(19) United States
(12) Patent Application Publication
(10) Pub. No.: US 2008/0124532 A1
(43) Pub. Date: May 29, 2008

(54) MATERIALS AND OLIGOMERS IN LOW VOC COATINGS

(75) Inventors: GREGORY H. MENOVCIK, NORTHVILLE, MI (US); PAUL J. HARRIS, WEST BLOOMFIELD, MI (US); SERGIO BALATAN, WEST BLOOMFIELD, MI (US); NICHOLAS CAIOZZO, ST. CLAIR SHORES, MI (US); WALTER H. OHRBOM, HARTLAND TOWNSHIP, MI (US); DONALD H. CAMPBELL, HARTLAND TOWNSHIP, MI (US)

Correspondence Address: BASF CORPORATION;Patent Department, 1609 BIDDLE AVENUE, MAIN BUILDING, WYANDOTTE, MI, 48192, US

(73) Assignee: BASF CORPORATION, SOUTHFIELD, MI (US)

(21) Appl. No.: 11/840,411

(22) Filed: Aug. 17, 2007

Related U.S. Application Data
(60) Provisional application No. 60/867,591, filed on Nov. 29, 2006.

(51) Int. Cl. B32B 7/02; C08G 18/83; C08G 63/08; C08G 63/123

(52) U.S. Cl. 428/217; 525/417; 525/418; 525/437; 525/450; 525/452; 525/50

(57) ABSTRACT

A coating composition comprises a thermosetting binder, comprising a crosslinker, a first, hard material having functionality reactive with the crosslinker, and a second, soft material having functionality reactive with the crosslinker. The first, hard material is a polymer, oligomer or compound, the first material having a glass transition temperature of at least 40° C., a number average molecular weight of 2000 or less, and an equivalent weight of 150 to 600 grams per equivalent of functionality reactive with the crosslinker. The second, soft material is a compound that is an amorphous mixture of four or more isomers, near isomers, and/or homologous structures and has from two to four functional groups that form thermally irreversible linkages with the crosslinker under cure conditions, wherein each functional group is separated from each other functional group by at least four atoms. The first, hard material may also have an equivalent weight of about 220 to about 850 grams per equivalent of functionality reactive with the crosslinker or with at least one of the plurality of crosslinkers under cure conditions and be a material, which, if reacted alone with the crosslinker or with the at least one of the plurality of crosslinkers, would form a film having a Tukon hardness of 16 or more, the second, soft material may also have an equivalent weight of 200 to 2000 grams per equivalent of functionality reactive with the crosslinker or with at least one of the plurality of crosslinkers under cure conditions and be a material, which, if reacted alone with the crosslinker or with the at least one of the plurality of crosslinkers, would form a film having a Tukon hardness of less than 4, while the coating composition forms a cured film having a Tukon hardness of from about 7 to about 12.

### CROSS-REFERENCE TO RELATED APPLICATION

This application claims priority to U.S. Provisional Patent Application No. 60/867,591, filed Nov. 29, 2006.

### FIELD

The present disclosure concerns coating compositions, especially thermosetting industrial coating compositions, particularly for automotive topcoats, coating methods, and coated articles prepared from the coating compositions.

### BACKGROUND

This section provides background information related to the present disclosure that may or may not be prior art.

Curable thermoset coating compositions are widely used in the coatings art. They are often used as topcoats in the automotive and industrial coatings industry. Such topcoats may be basecoats, clearcoats, or one-coat topcoats. Color-plus-clear (or basecoat-clearcoat) composite coatings are particularly useful as topcoats where exceptional gloss, depth of color, distinctness of image, or special metallic effect is desired. The automotive industry has made extensive use of these coatings for automotive body panels and trim parts such as bumpers.

Color-plus-clear composite coatings, however, require an extremely high degree of clarity in the clearcoat to achieve the desired visual effect. High-gloss coatings also require a low degree of visual aberrations at the surface of the coating in order to achieve the desired visual effect such as high distinctness of image (DOI). Finally, such composite coatings must also simultaneously provide a desirable balance of finished film properties such as durability, hardness, flexibility, and resistance to environmental etch, scratching, marring, solvents, and/or acids.

In order to obtain the extremely smooth finishes that are generally required in the coatings industry, coating compositions must exhibit good flow before curing. Good flow is observed when the coating composition is fluid enough at some point after it is applied to the substrate and before it cures to a hard film to take on a smooth appearance. Some coating compositions exhibit good flow immediately upon application and others exhibit good flow only after the application of elevated temperatures.

One way to impart fluid characteristics and good flow to a coating composition is to incorporate volatile organic solvents into the composition. These solvents provide the desired fluidity and flow during the coating process, but evaporate upon exposure to elevated curing temperatures, leaving only the coating components behind.

However, the use of such solvents increases the volatile organic content (VOC) of the coating composition. Because of the adverse impact that volatile organic solvents may have on the environment, many government regulations impose limitations on the amount of volatile solvent that can be used. Increasing the percentage nonvolatile (% NV) of a coating composition or decreasing the VOC, provides a competitive advantage with respect to environmental concerns, air permitting requirements and cost.

There is a continuing desire to reduce the volatile organic content (VOC) of coating compositions and the components of such coating compositions while avoiding the problems of the prior art. This must be done without sacrificing the Theological properties of the coating composition required for trouble-free application of the composition while still maintaining the optimum level of smoothness and appearance. Finally, any such coating composition must continue to provide finished films having a good combination of properties with respect to durability, hardness, flexibility, and resistance to chipping, environmental etch, scratching, marring, solvents, and/or acids.

More particularly, it would be desirable to provide a reactive polymer composition comprising a film-forming component polymerized in a material that is inert with respect to polymerization but does not volatilize upon exposure to elevated curing temperature. Ideally, such a material would enter into the film-forming reaction of a thermosetting coating composition incorporating said film-forming component. The desired effect of incorporating the material into the final film would be to increase the crosslink density of the coating and to impart positive film attributes such as etch resistance, flexibility, scratch and mar, or chip resistance.

Accordingly, it would be advantageous to provide a reactive polymer composition useful in a curable coating composition that provides many of the advantages of prior art binders, but which contributes lower levels of volatile organic solvents to the curable coating composition while still providing desirable application properties as well as finished films having commercially acceptable appearance and performance properties, especially with respect to scratch and mar resistance.

### SUMMARY

A coating composition comprises a thermosetting binder, comprising a crosslinker or plurality of crosslinkers, a first, hard material having functionality reactive with the crosslinker or with at least one crosslinker of the plurality of crosslinkers, and a second, soft material having functionality reactive with the crosslinker or with at least one crosslinker of the plurality of crosslinkers. The first, hard material is a polymer, oligomer or compound, the first material having a glass transition temperature of at least about 40° C., a number average molecular weight of about 2000 or less, and an equivalent weight of about 150 to about 600 grams per equivalent of functionality reactive with the crosslinker or with the at least one crosslinker of the plurality of crosslinkers. The resulting crosslinks formed by reaction with the first, hard material with the crosslinkers may be thermally reversible, thermally irreversible, or a combination of both. The second, soft material is an amorphous mixture of at least four isomeric compounds, compounds that are near isomers (by which is meant that the difference in structure includes a difference of one or two hydrogens), or homologous structures, or combinations of these, each molecule of which may be asymmetric. Each molecule of the second, soft material has from two to four functional groups, at least two of which form thermally irreversible linkages with a crosslinker under cure conditions, wherein each functional group is separated from each other functional group by at least four carbon atoms, and may be separated by other kinds of atoms in addition to the four or more carbon atoms. The mixture of second soft material molecules preferably has a polydispersity of about 1.5 or less. The coating composition may be nonaqueous. the functionalities react with the crosslinker or crosslinkers under cure conditions, which is to say that the reaction takes place when the coating composition is cured to a thermoset coating film.

The coating composition may optionally contain other film forming materials, such as materials with only one group (on average per molecule) reactive with the crosslinker or at least one of a plurality of crosslinkers.

Oligomers are polymers having relatively few monomer units; generally, “oligomer” refers to polymers with ten or fewer monomer units. “Compounds” will refer to nonpolymeric materials. The glass transition temperature of a material may be determined theoretically, for example by the Fox equation, or measured by differential scanning calorimetry (DSC). The molecular weight of a material may be determined by gel permeation chromatography (GPC), particularly by using polysytrene standards when the material is an oligomer or polymer. The term “thermally irreversible linkage” refers to a linkage the reversal of which is not thermally favored under the traditional cure schedules used for automotive coating compositions. Illustrative examples of suitable thermally irreversible chemical linkages are urethanes, ureas, esters and ethers. Preferred thermally irreversible chemical linkages are urethanes, ureas and esters, with urethane linkages being most preferred. Such chemical linkages will not break and reform during the crosslinking process as is the case with the linkages formed via reaction between hydroxyl groups and aminoplast resins. It should be understood that in special cases additional functional groups can be formed during the formation of a thermally irreversible crosslink during cure. For instance, a hydroxyl group may be formed during reaction of an epoxide group with an acidic hydrogen. The additional functional group (e.g., hydroxyl) formed during formation of the thermally irreversible crosslink may also react with the crosslinker or one of a plurality of crosslinkers, and may form a thermally reversible or thermally irreversible bond.

The coating compositions of the invention can be prepared at spray application viscosities with very little organic solvent. Because of the unique nature of the blend of components, the compositions provide cured coatings with both excellent appearance and excellent durability.

In another aspect, we disclose coating compositions that include a crosslinker and (1) a first material that has a plurality of crosslinkable groups and an equivalent weight from about 220 to about 850 grams per equivalent, which, if reacted alone with the crosslinker of the coating composition, would form a film having a Tukon hardness of 16 or more; and (2) a second material that has a plurality of crosslinkable groups and an equivalent weight from about 200 to about 2000 grams per equivalent, which, if reacted alone with the crosslinker, would form a film having of Tukon hardness of less than 4. The first material and the second material are used in amounts such that the Tukon hardness of a cured film of the coating composition has a Tukon hardness of from about 7 to about 12. Lower Tukon hardness allows unacceptable dirt retention; higher Tukon hardness has poorer chip resistance and cracking on standard automotive coatings testing. The coating obtained with the combination of the first and second materials has properties superior to those that could be obtained using a single material having an average of the properties of the two materials.

“A” and “an” as used herein indicate “at least one” of the item is present; a plurality of such items may be present, when possible. Other than in the working examples provides at the end of the detailed description, all numerical values of parameters (e.g., of quantities or conditions) in this specification, including the appended claims, are to be understood as being modified in all instances by the term “about.”“About” when applied to values indicates that the calculation or the measurement allows some slight imprecision in the value (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring such parameters. In addition, disclosure of ranges includes disclosure of all values and further divided ranges within the entire range.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

The coating composition comprises a thermosetting binder, comprising a crosslinker or plurality of crosslinkers, a first, hard material having functionality reactive with the crosslinker (or with at least one crosslinker if there is a plurality of crosslinkers), and a second, soft material reactive with the crosslinker (or with at least one crosslinker if there is a plurality of crosslinkers). The first, hard material has a glass transition temperature of at least about 40° C., preferably at least about 60° C., and number average molecular weight of 2000 or less, and an equivalent weight of about 150 to about 600, preferably about 170 to about 570, grams per equivalent of functionality reactive with the crosslinker or at least one crosslinker of a plurality of crosslinkers. Suitable examples of functionality reactive with crosslinkers that may be included are, without limitation, active hydrogen-containing functional groups such as carbamate groups, terminal urea groups, hydroxyls, carboxyls, cyclic anhydrides, epoxide groups, alkoxy silane groups, aminoplast functional groups, isocyanate, (blocked or unblocked), cyclic carbonate, amine, aldehyde, and combinations of these. The reaction of the functional groups of the first, hard material may produce chemical linkages that may or may not be thermally reversible. Preferred functional groups (ii) are hydroxyl, primary carbamate, isocyanate, aminoplast functional groups, epoxy, carboxyl and mixtures thereof. Most preferred functional groups (ii) are hydroxyl, primary carbamate, and mixtures thereof. These preferences pertain regardless of whether a thermally reversible or irreversible linkage is desired. It will be appreciated by those of skill in the art that it is the selection of a corresponding reactable functional groups in either film-forming components (b) or crosslinking components (c) that determine whether resulting linkages will be thermally reversible or irreversible.

Aminoplast functional groups may be defined as those functional groups resulting from the reaction of an activated amine group and an aldehyde or a formaldehyde. Illustrative activated amine groups are melamine, glycoluril, benzoguanamine, amides, carbamates, and the like. The resulting reaction product may be used directly as a functional group of the first, hard material or may be etherified with an alcohol prior to use as a functional group of the first, hard material. The aminoplast may be further modified to change some of its basic properties, for example, by the reaction with amides, to raise the T_{g} of the resulting material for use in powder coatings, as discussed in Balwant in U.S. Pat. No. 5,665,852.

Amine groups suitable for use as functional group of the first, hard material may be primary or secondary, but primary amines are most preferred.

In certain examples the first, hard material is an oligomer or polymer. In one embodiment, the first, hard material comprises an acrylic polymer. The acrylic polymer has a number average molecular weight as determined by GPC (using polystyrene standards) of about 2000 or less, preferably about 1500 or less, and a theoretical glass transition temperature, as determined from the Fox equation of at least about 40° C., preferably at least about 60° C. The acrylic polymer has an equivalent weight of from about 150 to about 600 grams per equivalent.

The acrylic polymer comprises functionality reactive with the crosslinker or at least one crosslinker if the coating composition contains a plurality of crosslinkers. In one preferred example of the invention, the first, hard material is an acrylic polymer comprising carbamate groups. The carbamate groups may be introduced to the polymer by either polymerizing using a carbamate-functional monomer or by reacting a functional group on the formed polymer in a further reaction to produce a carbamate group at that position. If the functional group on the acrylic polymer (b) is an isocyanate group, the isocyanate group can be reacted with a hydroxyalkyl carbamate, or with a hydroxy-containing epoxide with the epoxy group subsequently converted to carbamate by reaction with CO₂ and then ammonia. Preferably, an isocyanate-functional acrylic polymer is reacted with hydroxyethyl carbamate, hydroxypropyl carbamate, hydroxybutyl carbamate, or mixtures thereof. If the functional group is hydroxyl, the reactive group on the carbamate-containing compound may be oxygen of the C(═O)—O portion of the carbamate group on an alkyl carbamate or methylol, such as with methylol acrylamide (HO—CH—NH—C(═O)—CH═CH₂). In the case of the C(═O)—O group on an alkyl carbamate, the hydroxyl group on the polymer undergoes a transesterification with the C(═O)—O group, resulting in the carbamate group being appended to the polymer. In the case of methylol acrylamide, the unsaturated double bond is then reacted with peroxide to convert to an epoxy group, then CO₂, to form a cyclic carbonate, and then with ammonia or a primary amine to form the carbamate. If the functional group on the polymer is a carboxyl group, the carboxyl group can be reacted with epichlorohydrin to form a monoglycidyl ester, which can be converted to carbamate by reaction with CO₂, and then ammonia.

Carbamate functionality can also be introduced to the acrylic polymer by reacting the polymer with a compound that has a group that can be converted to a carbamate, and then converting that group to the carbamate. Examples of suitable compounds with groups that can be converted to a carbamate include, without limitation, active hydrogen-containing cyclic carbonate compounds (e.g., the reaction product of glycidol and CO₂) that are convertible to carbamate by reaction with ammonia, monoglycidyl ethers and esters convertible to carbamate by reaction with CO₂ and then ammonia, allyl alcohols where the alcohol group is reactive with isocyanate functionality and the double bond can be converted to carbamate by reaction with peroxide, and vinyl esters where the ester group is reactive with isocyanate functionality and the vinyl group can be converted to carbamate by reaction with peroxide, then CO₂, and then ammonia. Any of the above compounds can be utilized as compounds containing carbamate groups rather than groups convertible to carbamate by converting the group to carbamate prior to reaction with the polymer.

Such polymers can be prepared from ethylenically unsaturated monomers having at least one carbon-carbon double bond able to undergo free radical polymerization. Illustrative ethylenically unsaturated monomers include, without limitation, alpha, beta-ethylenically unsaturated monocarboxylic acids containing 3 to 5 carbon atoms such as acrylic, methacrylic, and crotonic acids, and the esters, nitriles, and amides of those acids; alpha, beta-ethylenically unsaturated dicarboxylic acids containing 4 to 6 carbon atoms and the anhydrides, monoesters, and diesters of those acids; vinyl esters, vinyl ethers, vinyl ketones, and aromatic or heterocylic aliphatic vinyl compounds. Carbamate functional ethylenically unsaturated monomers, cyclic carbonate functional ethylenically unsaturated monomers, and/or isocyanate functional ethylenically unsaturated monomers may also be used, most preferably in combination with other ethylenically unsaturated monomers. Representative examples of suitable esters of acrylic methacrylic, and crotonic acids include, without limitation, those esters from reaction with saturated aliphatic and cycloaliphatic alcohols containing 1 to 20 carbon atoms, such as methyl, ethyl, propyl, isopropyl, n-butyl, isobutyl, tert-butyl, 2-ethylhexyl, lauryl, stearyl, cycolhexyl, trimethylcyclohexyl, tetrahydrofurfuryl, stearyl, sulfoethyl, and isobomyl acrylates, methacrylates, and crotonates; and polyalkylene glycol acrylates and methacrylates. The functional group can be incorporated into the ester portion of the acrylic monomer. For example, hydroxy-functional acrylic monomers that can be used to form such polymers include hydroxyethyl acrylate, hydroxybutyl acrylate, hydroxybutyl methacrylate, hydroxypropyl acrylate, and the like; amino-functional acrylic monomers would include t-butylaminoethyl methacrylate and t-butylamino-ethylacrylate; acid-functional monomers would include acrylic acid, methacrylic acid, and itaconic acid; epoxide-functional monomers would include glycidyl acrylate and glycidyl methacrylate; ethylenically unsaturated isocyanate monomers such as meta-isopropenyl-α,α-dimethylbenzyl isocyanate (sold by American Cyanamid as TMI(®) and isocyanatoethyl methacrylate. Cyclic carbonate ethylenically unsaturated monomers are well-known in the art and include (2-oxo-1,3-dioxolan-4-yl)methyl methacrylate. Representative examples of other ethylenically unsaturated polymerizable monomers include, without limitation, such compounds as fumaric, maleic, and itaconic anhydrides, monoesters, and diesters with alcohols such as methanol, ethanol, propanol, isopropanol, butanol, isobutanol, and tert-butanol. Representative examples of polymerizable vinyl monomers include, without limitation, such compounds as vinyl acetate, vinyl propionate, vinyl ethers such as vinyl ethyl ether, vinyl and vinylidene halides, and vinyl ethyl ketone. Representative examples of aromatic or heterocylic aliphatic vinyl compounds include, without limitation, such compounds as styrene, alpha-methyl styrene, vinyl toluene, tert-butyl styrene, and 2-vinyl pyrrolidone. Representative examples include acrylic and methacrylic acid amides and aminoalkyl amides, acrylonitrile, and methacrylonitriles.

The functional monomers and comonomers are selected and apportioned to provide a glass transition temperature of at least about 40° C., preferably at least about 60° C., and an equivalent weight of from about 150 to about 600 grams per equivalent. Polymerization conditions (e.g., initiator type and concentration, chain transfer agent, monomer concentration, reaction temperature, etc.) are selected to provide a number average molecular weight of about 2000 or less and a weight average molecular weight of about 4000 or less, preferably about 3000 or less.

One way to prepare carbamate functional acrylic polymers is to prepare an acrylic monomer having a carbamate functionality in the ester portion of the monomer. Such monomers are well-known in the art and are described, for example in U.S. Pat. Nos. 3,479,328, 3,674,838, 4,126,747, 4,279,833, and 4,340,497, 5,356,669, and WO 94/10211, the disclosures of which are incorporated herein by reference. One method of synthesis involves reaction of a hydroxy-functional monomer with cyanic acid (which may be formed by the thermal decomposition of urea) to form the carbamyloxy carboxylate (i.e., carbamate-modified (meth)acrylate). Another method of synthesis reacts an alpha,beta-unsaturated acid ester with a hydroxy carbamate ester to form the carbamyloxy carboxylate. Yet another technique involves formation of a hydroxyalkyl carbamate by reacting a primary or secondary amine or diamine with a cyclic carbonate such as ethylene carbonate. The hydroxyl group on the hydroxyalkyl carbamate is then esterified by reaction with acrylic or methacrylic acid to form the monomer. Other methods of preparing carbamate-modified acrylic monomers are described in the art, and can be utilized as well. The acrylic monomer can then be polymerized along with other ethylenically-unsaturated monomers, if desired, by techniques well-known in the art.

An alternative route for preparing a carbamate-functional polymer is to react an already-formed polymer such as an acrylic polymer with another component to form a carbamate-functional group appended to the polymer backbone, as described in U.S. Pat. No. 4,758,632, the disclosure of which is incorporated herein by reference. One technique for preparing acrylic polymers useful as the second component involves thermally decomposing urea (to give off ammonia and HNCO) in the presence of a hydroxy-functional acrylic polymer to form a carbamate-functional acrylic polymer. Another technique involves reacting the hydroxyl group of a hydroxyalkyl carbamate with the isocyanate group of an isocyanate-functional acrylic or vinyl monomer to form the carbamate-functional acrylic. Isocyanate-functional acrylics are known in the art and are described, for example in U.S. Pat. No. 4,301,257, the disclosure of which is incorporated herein by reference. Isocyanate vinyl monomers are well-known in the art and include unsaturated m-tetramethyl xylene isocyanate and isocyanatoethyl methacrylate. Yet another technique is to react the cyclic carbonate group on a cyclic carbonate-functional acrylic with ammonia in order to form the carbamate-functional acrylic. Cyclic carbonate-functional acrylic polymers are known in the art and are described, for example, in U.S. Pat. No. 2,979,514, the disclosure of which is incorporated herein by reference. Another technique is to transcarbamylate a hydroxy-functional acrylic polymer with an alkyl carbamate. A more difficult, but feasible way of preparing the polymer would be to transesterify an acrylate polymer with a hydroxyalkyl carbamate.

Hydroxyl functional acrylics can be prepared by copolymerization with a hydroxyl functional additional polymerizable monomer such as hydroxyethyl (meth)acrylate, hydroxylpropyl (meth)acrylate, and hydroxybutyl (meth)acrylate, where (meth)acrylate is used to indicate that the compound may be either acrylate or methacrylate. Modified acrylics can also be used. Such acrylics may be polyester-modified acrylics or polyurethane-modified acrylics, as is well-known in the art. Polyester-modified acrylics modified with epsilon-caprolactone are described in U.S. Pat. No. 4,546,046 of Etzell et al., the disclosure of which is incorporated herein by reference. Polyurethane-modified acrylics are also well-known in the art. They are described, for example, in U.S. Pat. No. 4,584,354, the disclosure of which is incorporated herein by reference. Preferably, such modified acrylics will also have carbamate functional groups.

The acrylic polymer may include epoxide groups by polymerization of glycidyl (meth)acrylate, carboxyl groups by polymerization of (meth)acrylic acid, maleic anhydride, and succinic anhydride, isocyanate groups by the polymerization of isocyanate-functional monomers such as TMI (sold by Cytec) or isocyanatoethyl (meth)acrylate, or alkoxy silane groups by polymerization of monomers such as trialkyoxypropylsilyl methacrylate. Functional groups can also be introduced to a monomer before or after polymerization, for example by reaction of a hydroxyalkyl (meth)acrylate with a cyclic anhydride.

The monomer with the functional group may be copolymerized with one or more ethylenically unsaturated comonomers. Such monomers for copolymerization are known in the art. They include alkyl esters of acrylic or methacrylic acid, e.g., ethyl acrylate, butyl acrylate, 2-ethylhexyl acrylate, butyl methacrylate, isodecyl methacrylate, and the like; and vinyl monomers such as unsaturated m-tetramethyl xylene isocyanate, styrene, vinyl toluene and the like.

In a second embodiment, the first, hard material comprises a β-hydroxy carbamate or γ-hydroxy carbamate compound having a structure

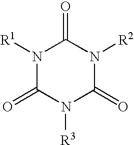

wherein each of R¹, R², and R³ independently comprises a carbamate group and a hydroxyl group on a carbon beta or gamma to the carbamate group. Such a group is formed by reaction of a cyclic carbonate group with ammonia, in which the cyclic carbonate is a five- or six-member ring. In one embodiment, each of R¹, R², and R³ independently is

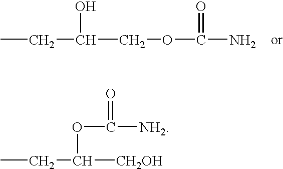

### In another embodiment, each of R¹, R², and R³ independently is

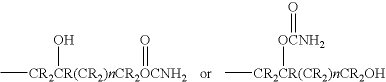

wherein each R is independently H or an alkyl group containing one to six carbon atoms and which may additionally have hetero atom linking groups of oxygen, nitrogen, silane, boron, phosphorous and combinations thereof, and n is an integer from 1 to 4. In certain examples of the invention the number of R groups that are alkyl groups is 0, 1, or 2 and n is 1.

In one synthesis, this first, hard material may be prepared by reacting triglycidyl isocyanurate first with carbon dioxide to convert the oxirane groups to cyclic carbonate groups, and then with ammonia or a primary amine to convert the cyclic carbonate group to a β-hydroxy carbamate group. The β-hydroxy carbamate compound may be prepared by reacting triglycidyl isocyanurate first with carbon dioxide to convert the oxirane groups to cyclic carbonate groups, and then with ammonia to convert the cyclic carbonate group to a β-hydroxy carbamate group. Triglycidyl isocyanurate is commercially available or may be prepared by reaction of isocyanuric acid with an epihalohydrin, in particular epichlorohydrin. The reaction of the triglycidyl isocyanurate can be done at any pressure from atmospheric up to supercritical CO₂ pressures, but is preferably under elevated pressure (e.g., 60-150 psi). The temperature for this reaction is preferably 60-150° C. Useful catalysts include any that activate an oxirane ring, such as tertiary amine or quaternary salts (e.g., tetramethyl ammonium bromide), combinations of complex organotin halides and alkyl phosphonium halides (e.g., (CH₃)₃SnI, Bu₄SnI, Bu₄PI, and (CH₃)₄PI), potassium salts (e.g., K₂CO₃, KI) preferably in combination with crown ethers, tin octoate, calcium octoate, and the like. In another synthesis, the first, hard material may be prepared with a gamma-hydroxy carbamate group as described in U.S. Pat. Nos. 6,812,300, 6,858,674, 6,900,270, 6,977,309, and 5,532,061.

Cyclic carbonate groups can be converted to carbamate groups by reaction with ammonia, which ring-opens the cyclic carbonate to form a β-hydroxy carbamate. The ammonia may be anhydrous ammonia or aqueous ammonia (i.e., NH₄OH). The carbonate ring can open to produce either of the two isomeric structures shown above for the R¹, R², and R³ groups.

In a third embodiment, the first, hard material comprises a carbamate functional compound again having a structure

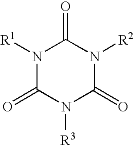

but wherein each of R¹, R², and R³ is independently

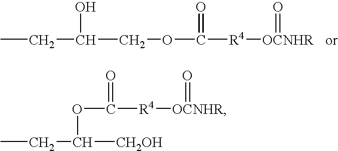

wherein R⁴ is alkylene (including cycloalkylene), alkylarylene, arylene, preferably alkylene, and R is H or alkyl, preferably H or alkyl of from 1 to 4 carbon atoms. In this embodiment, the first, hard material may be prepared by reacting triglycidyl isocyanurate with a compound containing one carboxyl group and one carbamate group. Nonlimiting examples of compounds containing one carboxyl group and one carbamate group include the reaction product of a cyclic anhydride with an hydroxyalkylcarbamate compound. Nonlimiting examples of suitable cyclic anhydrides include maleic anhydride, 1,2-cyclohexane anhydride, phthalic anhydride, hexahydrophthalic anhydride, glutaric anhydride, itaconic anhydride, trimellitic anhydride, pyromellitic dianhydride, and alkyl-substituted versions of these anhydrides where non-limiting examples of alkyl groups are groups that contain between 1 and 12 carbons, where the alkyl group may also contain heteroatom linking groups where non-limiting examples of such heteroatoms are oxygen, nitrogen, silane, phosphorous, and groups containing combinations of these, and where the alkyl side group can contain ethylenic unsaturation.

In a fourth embodiment, the first, hard material comprises a carbamate functional compound having at least two urethane or urea groups. Preferred compounds of this kind for the first, hard material may be represented by any of the structures

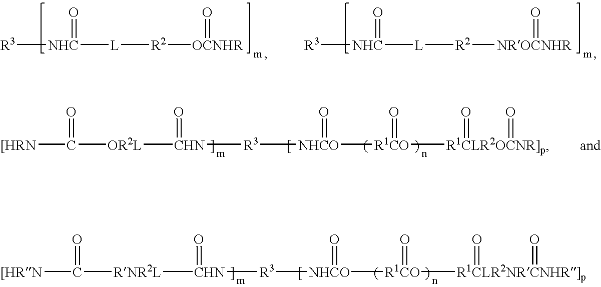

in which R is H or alkyl, preferably H or alkyl of from 1 to 4 carbon atoms, R′ and R″ are each independently H or alkyl or R′ and R″ together form a heterocyclic ring structure and preferably R′ and R″ are each independently H or alkyl of 1 to 4 carbon atoms or R′ and R″ together form an ethylene bridge; R′ is alkylene or arylalkylene, preferably alkylene, and particularly alkylene of 5 to 10 carbon atoms; R² is alkylene or substituted alkylene, preferably having from about 2 to about 4 carbon atoms; R³ is alkylene (including cycloalkylene), alkylarylene, arylene, or a structure that includes a cyanuric ring, a urethane group, a urea group, a carbodiimide group, a biuret structure, or an allophonate group, preferably alkylene (including cycloalkylene) or a structure that includes a cyanuric ring; n is an integer from 0 to about 10, preferably an integer from 0 to about 5; m is an integer from 2 to about 6, preferably 2 or 3; and L is O, NH, or NR⁴, where R⁴ is an alkyl, preferably an alkyl of 1 to about 6 carbon atoms; p is an integer from 1 to 5, preferably 1 or 2, and m+p is an integer from 2 to 6, preferably 3. Preferably, R, R′, and R″ are each H and R³ is alkylene (including cycloalkylene), alkylarylene, arylene, or a structure that includes a cyanuric ring. In certain embodiments R³ is a member selected from the group of hexamethylene (with m+p being 2),

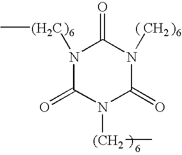

(m+p being 3),

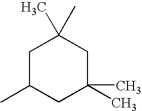

(m+p being 2),

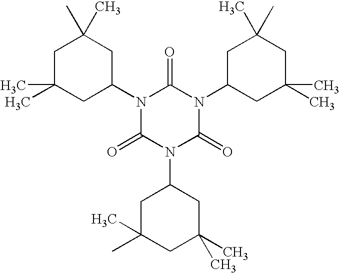

(m+p being 3), and mixtures of these. L is preferably an oxygen atom.

This embodiment of the first, hard material may be prepared by reacting together at least one polyisoyanate and a compound having a carbamate or terminal urea group or group that is converted to a carbamate or terminal urea group following reaction with the at least one polyisocyanate.

This embodiment of the first, hard material preferably has a carbamate or terminal urea group, more preferably a carbamate group, or may have a group that can be converted to a carbamate or terminal urea group. In the case when the first, hard material has a group that can be converted to carbamate or terminal urea, the conversion to the carbamate or terminal urea group is carried out either at the same time as the reaction involving the polyisocyanate or afterwards. Groups that can be converted to carbamate include cyclic carbonate groups, epoxy groups, and unsaturated bonds. Cyclic carbonate groups can be converted to carbamate groups by reaction with ammonia or a primary amine, which ring-opens the cyclic carbonate to form a beta-hydroxy carbamate. Epoxy groups can be converted to carbamate groups by first converting to a cyclic carbonate group by reaction with CO₂. This can be done at any pressure from atmospheric up to supercritical CO₂ pressures, but is preferably under elevated pressure (e.g., 60-150 psi). The temperature for this reaction is preferably 60-150° C. Useful catalysts include any that activate an oxirane ring, such as tertiary amine or quaternary salts (e.g., tetramethyl ammonium bromide), combinations of complex organotin halides and alkyl phosphonium halides (e.g., (CH₃)₃SnI, Bu₄SnI, Bu₄PI, and (CH₃)₄PI), potassium salts (e.g., K₂CO₃, KI) preferably in combination with crown ethers, tin octoate, calcium octoate, and the like. The cyclic carbonate group can then be converted to a carbamate group as described above. Any unsaturated bond can be converted to a carbamate group by first reacting with peroxide to convert to an epoxy group, then with CO₂ to form a cyclic carbonate, and then with ammonia or a primary amine to form the carbamate.

Other groups, such as hydroxyl groups or isocyanate groups can also be converted to carbamate groups. However, if hydroxyl groups were to be present on the compound and it is desired to convert those groups to carbamate after the reaction with the polyisocyanate, they would have to be blocked or protected so that they would not react during the initial reaction or else in stoichiometric excess so that some would be expected to remain unreacted for later conversion to the carbamate or terminal urea group(s). Conversion to carbamate or urea could also be carried out prior to the reaction with polyisocyanate. Hydroxyl groups can be converted to carbamate groups by reaction with a monoisocyanate (e.g., methyl isocyanate) to form a secondary carbamate group (that is, a carbamate of the structure above in which R is alkyl) or with cyanic acid (which may be formed in situ by thermal decomposition of urea) to form a primary carbamate group (i.e., R in the above carbamate group formula is H). This reaction preferably occurs in the presence of a catalyst as is known in the art. A hydroxyl group can also be reacted with phosgene and then ammonia to form a primary carbamate group, or by reaction of the hydroxyl with phosgene and then a primary amine to form a compound having secondary carbamate groups. Another approach is to react an isocyanate with a compound such as hydroxyalkyl carbamate to form a carbamate-capped isocyanate derivative. For example, one isocyanate group on toluene diisocyanate can be reacted with hydroxypropyl carbamate, followed by reaction of the other isocyanate group with an excess of polyol to form a hydroxy carbamate. Finally, carbamates can be prepared by a transesterification approach where hydroxyl group is reacted with an alkyl carbamate (e.g., methyl carbamate, ethyl carbamate, butyl carbamate) to form a primary carbamate group-containing compound. This reaction is performed at elevated temperatures, preferably in the presence of a catalyst such as an organometallic catalyst (e.g., dibutyltin dilaurate). Other techniques for preparing carbamates are also known in the art and are described, for example, in P. Adams & F. Baron, “Esters of Carbamic Acid”, Chemical Review, v. 65, 1965.

Groups such as oxazolidone can also be converted to terminal urea groups. For example, hydroxyethyl oxazolidone can be used to react with the polyisocyanate, followed by reaction of ammonia or a primary amine with the oxazolidone to generate the terminal urea functional group.

In addition to the carbamate or terminal urea group or the group that can be converted to a carbamate or terminal urea group, the compound also has a group that is reactive with isocyanate functionality. Suitable groups that are reactive with isocyanate functionality include, without limitation, hydroxyl groups, primary amine groups, and secondary amine groups. Preferably, the compound reacted with the polyisocyanate has hydroxyl groups or primary amine groups as the groups reactive with isocyanate functionality, and more preferably hydroxyl groups. The compound has at least one group that is reactive with isocyanate functionality, and preferably it has from 1 to about 3 of such groups, and more preferably it has one such reactive group. In a preferred embodiment, the compound has a carbamate group and a hydroxyl group. One preferred example of such a compound is a hydroxyalkyl carbamate, particularly a beta-hydroxyalkyl carbamate. In another preferred embodiment, the compound reacted with the polyisocyanate has a terminal urea group and a hydroxyl group.

Suitable compounds reactive with the polyisocyanate include, without limitation, any of those compounds having a carbamate or terminal urea group and a hydroxyl or primary or secondary amine group. Illustrative examples of suitable compounds of this type include, without limitation, hydroxy alkyl carbamates and hydroxyalkylene alkyl ureas, such as hydroxyethyl carbamate, hydroxypropyl carbamate, and hydroxyethylene ethyl urea. Hydroxypropyl carbamate and hydroxyethyl ethylene urea, for example, are well known and commercially available. Amino carbamates are described in U.S. Pat. No. 2,842,523. Compounds with hydroxyl and terminal urea groups may also be prepared by reacting the amine group of an amino alcohol with hydrochloric acid and then urea to form a hydroxy terminal urea compound. An amino alcohol can be prepared, for example, by reacting an oxazolidone with ammonia. Amino terminal urea compounds can be prepared, for example, by reacting a ketone with a diamine having one amine group protected from reaction (e.g., by steric hindrance), followed by reaction with HNCO (e.g., as generated by thermal decomposition of urea), and finally reaction with water. Alternatively, these compounds can be prepared by starting with a compound having the group that can be converted to carbamate or terminal urea, which groups are described below, and converting that group to the carbamate or urea prior to beginning the reaction with the polyisocyanate.

Other suitable compounds to be reacted with the polyisocyanate include those having a group reactive with the polyisocyanate and a group that can be converted to carbamate such as hydroxyalkyl cyclic carbonates. Certain hydroxyalkyl cyclic carbonates like 3-hydroxypropyl carbonate (i.e., glycerine carbonate) are commercially available. Cyclic carbonate compounds can be synthesized by any of several different approaches. One approach involves reacting an epoxy group-containing compound with CO₂ under conditions and with catalysts as described hereinabove. Epoxides can also be reacted with beta-butyrolactone in the presence of such catalysts. In another approach, a glycol like glycerine is reacted at temperatures of at least 80° C. with diethyl carbonate in the presence of a catalyst (e.g., potassium carbonate) to form a hydroxyalkyl carbonate. Alternatively, a functional compound containing a ketal of a 1,2-diol having the structure:

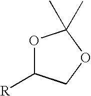

can be ring-opened with water, preferably with a trace amount of acid, to form a 1,2-glycol, the glycol then being further reacted with diethyl carbonate to form the cyclic carbonate.

Cyclic carbonates typically have 5- or 6-membered rings, as is known in the art. Five-membered rings are preferred, due to their ease of synthesis and greater degree of commercial availability. Six-membered rings can be synthesized by reacting phosgene with 1,3-propanediol under conditions known in the art for the formation of cyclic carbonates. While the hydroxy carbamate group formed from ring opening of six-member cyclic carbonate is more stable than that from opening of five-member ring, the five-member ring is more readily available and less expensive. Preferred hydroxyalkyl cyclic carbonates used in the practice of the invention can be represented by the formula:

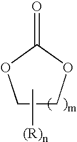

in which R (or each instance of R if n is more than 1) is a hydroxyalkyl group of 1-18 carbon atoms, preferably 1-6 carbon atoms, and more preferably 1-3 carbon atoms, which may be linear or branched and may have substituents in addition to the hydroxyl group, m is 1, 2, or 3, preferably 1 or 2, and n is 1 or 2, which may be substituted by one or more other substituents such as blocked amines or unsaturated groups. The hydroxyl group may be on a primary, secondary, or tertiary carbon. More preferably, R is —(CH₂)ₚ—OH, where the hydroxyl may be on a primary or secondary carbon and p is 1 to 8, and even more preferably in which the hydroxyl is on a primary carbon and p is 1 or 2.

Suitable examples of polyisocyanate compounds include both aliphatic polyisocyanates and aromatic polyisocyanates. Useful polyisocyanates include monomeric isocyanates, for example aliphatic diisocyanates such as ethylene diisocyanate, 1,2-diisocyanatopropane, 1,3-diisocyanatopropane, 1,6-diisocyanatohexane (hexamethylene diisocyanate or HDI or HMDI), 1,4-butylene diisocyanate, lysine diisocyanate, 1,4-methylene bis-(cyclohexyl isocyanate) and isophorone diisocyanate (IPDI), and aromatic diisocyanates and arylaliphatic diisocyanates such as the various isomers of toluene diisocyanate, meta-xylylenediioscyanate and para-xylylenediisocyanate, 4-chloro-1,3-phenylene diisocyanate, 1,5-tetrahydro-naphthalene diisocyanate, 4,4′-dibenzyl diisocyanate, and 1,2,4-benzene triisocyanate. In addition, the various isomers of α,α,α′,α′-tetramethyl xylylene diisocyanate can be used. Isocyanate-functional oligomers or low molecular weight reaction products of the monomeric isocyanates, which may have from 2 to about 6 isocyanate groups, may also be used. Examples of these include isocyanurates and the reaction products of excess isocyanate with polyols, such as the product of three moles of diisocyanate with a mole of a triol (e.g., 3 moles of IPDI with one mole of trimethylolpropane or two moles of IPDI with one mole of neopentyl glycol); reaction products of isocyanate with urea (biurets); and reaction products of isocyanate with urethane (allophanates). The polyisocyanate preferably has two to four isocyanate groups, and more preferably the polyisocyanate has 2 or 3 isocyanate groups per molecule. Isocyanurates such as the isocyanurates of isophorone diisocyanate or hexamethylene diisocyanate are particularly preferred. In one preferred embodiment, the polyisocyanate is isophorone diisocyanate, the isocyanurate of isophorone diisocyanate, hexamethylene diisocyanate, the isocyanurate of isophorone diisocyanate, or a combination of these. In another preferred embodiment, the polyisocyanate is an isocyanate-functional monomeric or oligomeric, preferably monomeric, reaction product of a diisocyanate and a polyol. Such a reaction product may prepared by reacting one mole of a diisocyanate per equivalent of polyol. This endcapping is preferably accomplished by reacting at least two equivalents of isocyanate of a diisocyanate for each equivalent of hydroxyl of the polyol. The diisocyanate is preferably isophorone diisocyanate or hexamethylene diisocyanate. The polyol is preferably 2-ethyl-1,6-hexanediol, trimethylolpropane, neopentyl glycol, or a combination of these.

In one preferred example of this fourth embodiment, the first, hard material is produced by a step that includes reacting a mixture of an isocyanate (preferably a diisocyanate, e.g., HDI, IPDI, or the isocyanate-functional endcapped polyol described in the previous paragraph) and a compound such as hydroxypropyl carbamate to form a carbamate-capped polyisocyanate derivative, as described in U.S. Pat. No. 5,512,639.

In a further example of this fourth embodiment of the first, hard material, the reaction mixture includes, in addition to polyisocyanate and the compound reactive with the polyisocyanate, an active-hydrogen chain extension agent. Chain extension agents may be used to increase the length of the compound having at least one carbamate group or terminal urea group and having at elast two urethane or urea linking groups or to bridge together two or more such compounds. Useful active hydrogen-containing chain extension agents generally contain at least two, preferably about two, active hydrogen groups, for example, diols, dithiols, diamines, or compounds having a mixture of hydroxyl, thiol, and amine groups, such as alkanolamines, aminoalkyl mercaptans, and hydroxyalkyl mercaptans, among others. For purposes of this aspect of the invention, both primary and secondary amine groups are considered as having one active hydrogen. Active hydrogen-containing chain extension agents also include water. In a preferred embodiment, a polyol is used as the chain extension agent. In an especially preferred embodiment, a diol is used as the chain extension agent with little or no higher polyols, so as to minimize branching. Examples of preferred chain extension agents include, without limitation, 1,6-hexanediol, 1,2-hexanediol, 2-ethyl-1,3-hexanediol, 2-ethyl-1,6-hexanediol, 3-hydroxy-2,2-dimethylpropyl 3-hydroxy-2,2-dimethylpropionate (sold by Eastman Chemical Co. as Esterdiol 204), 1,4-butanediol, 1,5-pentanediol, neopentyl glycol, cyclohexanedimethanol (sold as CHDM by Eastman Chemical Co.), ethylpropyl-1,5-pentanediol, 2-methyl-2,4-pentanediol, 2,2,4-trimethyl- 1,3 -pentanediol, 2,4,7,9-tetramethyl-5-decyn-4,7-diol, 1,3-dihydroxyacetone dimer, 2-butene-1,4-diol, pantothenol, dimethyltartrate, pentaethylene glycol, dimethyl silyl dipropanol, and 2,2′-thiodiethanol. While polyhydroxy compounds containing at least three hydroxyl groups may be used as chain extenders, the use of these compounds may produce higher molecular weight, more branched compounds. Higher-functional polyhydroxy compounds include, for example, trimethylolpropane, trimethylolethane, pentaerythritol, among other compounds. In a particularly preferred embodiment, the monomeric isocyanate is a diisocyanate, especially isophorone or hexamethylene diisocyanate and an average of one of the isocyanate groups per molecule is reacted with the compound comprising a group that is reactive with isocyanate and a carbamate group or group that can be converted into a carbamate group, preferably with hydroxypropyl carbamate, and the remaining isocyanate groups are reacted with a polyol, particularly with 2-ethyl-1,6-hexanediol. The reactions of the polyisocyanate with compound providing the carbamate or urea group and with the chain extension compound can be carried out in any order, including concurrently. While a mixture of reaction products may be expected each of the isocyanate groups has about the same reactivity, at least a part should be the idealized product in which a molecule of the polyisocyanate has reacted with both a compound providing the carbamate or urea group and the chain extension compound.

Another method of synthesis of the compound of this embodiment is to first react the isocyanate groups of a polyisocyanate with a compound having a group that is reactive with isocyanate and also a non-isocyanate functional group. This adduct is then reacted with a compound comprising at least one carbamate group or group that can be converted to carbamate and at least one group reactive with the non-isocyanate functional groups. Examples of non-isocyanate functional groups include carboxyl, epoxy, hydroxyl, amino. Suitable examples of methods for converting such groups to carbamate or urea groups have already been described above in detail.

In a fifth embodiment, the first, hard material comprises a compound having a structure

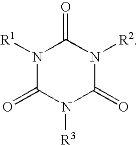

wherein each of R¹, R², and R³ is independently

CH₂CH₂LR⁴F

wherein L is a urethane or ester group, R⁴ is alkylene (including cycloalkylene), alkylarylene, arylene, preferably alkylene, and F is an alkyl group comprising a functionality reactive with the crosslinker or at least one crosslinker if the coating composition contains a plurality of crosslinkers.

The hard material of this fifth embodiment can be prepared by reaction of tris-hydroxyethyl isocyanurate with an isocyanate-functional material having a functional group reactive with the crosslinking agent. In one example, a diisocyanate is half-blocked with trishydroxyethyl isocyanurate in a molar ratio of three moles of the diisocyanate to one mole of tris-hydroxyethyl isocyanurate to provide an isocyanate functional first, hard material. The diisocyanate is preferably one in which the isocyanate groups have differing reactivities to minimize oligomerization. A carbamate functional material may be obtained by reacting this isocyanate functional product with a hydroxyalkyl carbamate, such as hydroxyethyl carbamate, beta-hydroxypropyl carbamate, or gamma-hydroxypropyl carbamate. An hydroxyl functional material may be obtained by reaction of this isocyanate functional product with an amino alcohol, such as dimethylaminoethanol.

Alternatively, the hard material of this fifth embodiment can be prepared by reaction of tris-hydroxyethyl isocyanurate with a cyclic anhydride to produce a carboxyl functional material. The carboxyl functional material can be used with a crosslinker having groups reactive with carboxyl groups, such as a polyepoxide crosslinking agent, or can be derivatized to provide a different functional group.

In an example of this alternative, the hard material of the fifth embodiment, tris-hydroxyethyl isocyanurate is reacted with a cyclic anhydride such as maleic anhydride, malonic anhydride, succinic anhydride, and phthalic anhydride to produce a carboxyl functional material. Hydroxyl functional groups can be obtained by reduction of the carboxyl groups. Carbamate functional groups may be obtained by esterification of the carboxyl-functional groups with a hydroxyalkyl carbamate, such as hydroxyethyl carbamate or hydroxypropyl carbamate. An amine functional hard material of the fifth embodiment can be obtained by reaction of the acid functional product to form an amide, followed by conversion to a nitrile and subsequent reduction to an amine. Isocyanate functional groups may be obtained via reaction of the amine functional soft material with carbon dioxide. aminoplast functional groups may be made via reaction of the carbamate or amide functional materials as described above with formaldehyde or aldehyde. The resulting reaction product may optionally be etherified with low boiling point alcohols such a methanol, ethanol, propanol, isopropanol, butanol, and isobutanol. Urea functional groups may be made via reaction of the amine functional material with urea. Alternatively, amine functional hard material of the fifth embodiment can be reacted with phosgene followed by reaction with ammonia to produce the desired urea functional groups. Epoxy functional groups may be obtained from an acid or hydroxyl functional material by reaction with epichlorohydrin. Cyclic carbonate functional groups may be made via carbon dioxide insertion into an epoxy functional group.

In addition to the first, hard material, the coating composition comprises a second, soft material also having functionality reactive with the crosslinker or at least one crosslinker if the coating composition contains a plurality of crosslinkers. The second, soft material of the coating composition is a compound that is an amorphous mixture of four or more isomers, near isomers homologous structures, or combinations of these, and has from two to four functional groups, at least two of which form thermally irreversible linkages with a crosslinker in the coating composition under cure conditions. Each functional group is separated from each other functional group by at least four carbon atoms. In some examples of the second, soft material, each functional group is separated from each other functional group by at least six carbon atoms, and in other examples each functional group is separated from each other functional group by at least ten carbon atoms. In some embodiments, atoms other than carbon atoms may also separate functional groups.

The second, soft material is an amorphous mixture; that is, if isolated from the coating composition, it is not crystalline when solid, and thus is not characterized by a regular, ordered arrangement. The second, soft material may be a wax or liquid at room temperature, noncrystalline, with no well-defined ordered structure. The second, soft material is a mixture of four or more isomeric, near isomeric, or homologous structures, or combinations of these; that is, it is a mixture of four or more molecules, each of which, in relation to one or more of the other three molecules, either (1) has the same molecular formula but which is a different compound, (2) has a molecular formula differing by one or two hydrogen atoms, or (3) is related as a homolog, especially a homolog having a molecular formula that differs by (CH₂)n. The four or more structures may be in any combination of isomers, near isomers, and homologs. It should be noted that, while the mixture of four or more isomeric or homologous structures (or combinations of isomeric and homolgous structures) is non-crystalline, the individual structures, if isolated from the mixture, may themselves be crystalline or non-crystalline. Thus, it may be possible to physically isolate one structure as crystalline by a precipitation technique. It should also be noted that the purity of the reagents that may be used to prepare the mixture of four or more molecules, as well as side reactions that can occur, could result in a limited number of structures in the soft, second material having a slightly different molecular formula; such mixtures will also fall under the present definition of the mixture of four or more isomeric or homologous structures.

The second, soft material has a polydispersity of about 1.5 or less. In some embodiments, it is preferred for the second soft material to have a polydispersity of about 1.2 or less. Polydispersity may be determined as the ratio of weight average molecular weight over number average molecular weight, where the weight and number average molecular weights may be determined by gel permeation chromatography using polystyrene standards.

In some embodiments, at least one of the structures of the second, soft material is asymmetric. In a first embodiment of the present invention, “asymmetric” means that, outside of the identity element, the materials does not posses any other symmetry elements as defined by “Molecular Symmety and Group Theory by Alan Vincent, John Wiley and Sons, August 1981. In a second embodiment of the present invention, “asymmetric” means that the material is made up of a series of related materials of similar molecular weight that each have different structures and different symmetry elements. A simple example of asymmetry according to this second definition would be the mixture of n-butanol, i-butanol, and t-butanol. When taken as a mixture, this mixture of three alcohols will have different structures and symmetry elements. Also included in this definition are materials which have similar but different molecular formulas due to how the material is processed. An example of this is the reaction product from the dimerization of C18 fatty acids. The fatty acid dimer contains materials in which some of the dimers contain cyclic, aromatic, and different degrees of alkene groups. While the dimer of fatty acid is made up of a series of different materials, those skilled in the art refer to all of the materials as if it is one material.

The second, soft material must comprise at least two functional groups and may have from two to four functional groups, while most preferably the second, soft material will have two or three functional groups. The functional groups react during cure of the coating composition. The reaction of the functional groups with the crosslinker forms thermally irreversible linkages under cure conditions. The term “thermally irreversible linkage” as used herein refers to a linkage the reversal of which is not thermally favored under the traditional cure schedules used for automotive coating compositions. Illustrative examples of suitable thermally irreversible chemical linkages are urethanes, ureas, esters and non-aminoplast ethers. Preferred thermally irreversible chemical linkages are urethanes, ureas and esters, with urethane linkages being most preferred. Such chemical linkages will not break and reform during the crosslinking process as is the case with the linkages formed via reaction between hydroxyl groups and aminoplast resins.

Certain pairs of functional groups will produce such thermally irreversible chemical linkages. If one member of a pair is selected for use as a functional group of the second, soft material, the other member of the pair will be selected as the functional group of the crosslinking agent. Examples of illustrative reactant or functional group pairs producing thermally irreversible linkages are hydroxy/isocyanate (blocked or unblocked), hydroxy/epoxy, carbamate/aminoplast, carbamate/aldehyde, acid/epoxy, amine/cyclic carbonate, amine/isocyanate (blocked or unblocked), urea/aminoplast, and the like.

Illustrative suitable functional groups for the second, soft material are selected from the group consisting of carboxyl, hydroxyl, epoxy, carbamate, isocyanate, and mixtures thereof. Most preferred functional groups (ii) are hydroxyl, primary carbamate, and mixtures thereof. In one embodiment, the functional group may be able to form two crosslinks. For example, when the functional group is a beta hydroxy carbamate, both the carbamate group and the hydroxy group can undergo crosslinking reactions. In another non-limiting example, when the functional group is an acid, it can react with an epoxy to generate a beta hydroxy ester which can then undergo an additional crosslinking reaction through the hydroxyl group.

In a first embodiment, the four or more molecules will comprise a mixture of two or more saturated or unsaturated structures selected from the group consisting of noncyclic structures for the second, soft material, aromatic-containing structures for the second, soft material, cyclic-containing structures for the second, soft material, and mixtures thereof. Saturated structures and aromatic structures that are free of non-aromatic unsaturated sites are preferred, especially where durability issues are of concern. For example, the four or more molecules may comprises a mixture of two or more structures selected from the group consisting of aliphatic structures, aromatic-containing structures, cycloaliphatic-containing structures, and mixtures thereof.

In a preferred example of the first embodiment, the second, soft material will comprise one or more aliphatic structures, optionally one or more aromatic-containing structures, and one or more cycloaliphatic-containing structures. Particularly advantageous mixtures for the second, soft material will comprise from 3 to 25% by weight of molecules with aliphatic structure, from 3 to 25% by weight of molecules with an aromatic-containing structure, and 50 to 94% by weight of molecules having a cycloaliphatic-containing structure. More preferred mixtures for the second, soft material will comprise from 3 to 18% by weight of molecules having an aliphatic structure, from 5 to 23% by weight of molecules having an aromatic-containing structure, and 55 to 85% by weight of molecules having a cycloaliphatic-containing structure. Most preferred mixtures of the second, soft material will comprise from 5 to 10% by weight of molecules having an aliphatic structure, from 10 to 20% by weight of molecules having an aromatic-containing structure, and 60 to 70% by weight of molecules having a cycloaliphatic-containing structure.

Examples of the first embodiment of the second, soft material having carboxyl functional groups are mixtures of fatty acids and addition reaction products thereof, such as dimerized, trimerized and tetramerized fatty acid reaction products and higher oligomers thereof. Suitable acid functional dimers and higher oligomers may be obtained by the addition reaction of C12-18 monofunctional fatty acids. Saturated and unsaturated dimerized fatty acids are commercially available from Uniquema of Wilmington, Del. When UV durability is of concerns, material with an iodine value of less than 40 is preferred, and material with an iodine level of less than 10 is particularly preferred.

Hydroxyl-functional materials suitable as the first embodiment of the second, soft component are commercially available as the Pripol™ saturated fatty acid dimer (Pripol™ 2033) supplied by Uniqema of Wilmington, Del. Hydroxyl functional second, soft material may also be obtained by reduction of the acid group of the fatty acids mentioned already or by reaction of a fatty acid with a mixture of epoxide-functional compounds. In one example, Cardura E10 from Hexion is reacted with a dicarboxylic acid or a cyclic anhydride, e.g. 1,12-dodecanedioic acid, succinic anhydride, or the reaction product of a fatty diol (e.g. 1,18-octadecanediol) with a cyclic anhydride (e.g. succinic anhydride).

A second, soft material of the first embodiment having two or more carbamate functional groups may be obtained via the reaction of the hydroxyl functional material just described with a low molecular weight carbamate functional monomer such as methyl carbamate under appropriate reaction conditions. Alternatively, carbamate functional soft, second material may be made via the decomposition of urea in the presence of the hydroxyl functional material. Finally, carbamate functional second, soft material can be obtained via the reaction of phosgene with the hydroxyl functional soft material just described, followed by reaction with ammonia.

A second, soft material of the first embodiment having amine functional groups may be obtained via reaction of the acid functional fatty acid material to form an amide, followed by conversion to a nitrile and subsequent reduction to an amine. Isocyanate functional groups may be obtained via reaction of the amine functional soft material with carbon dioxide.

A second, soft material of the first embodiment with aminoplast functional groups may be made via reaction of carbamate or amide functional soft materials as described above with formaldehyde or aldehyde. The resulting reaction product may optionally be etherified with low boiling point alcohols such a methanol, ethanol, propanol, isopropanol, butanol, and isobutanol.

Urea functional groups may be made via reaction of an amine functional soft, second material with urea. Alternatively, amine functional soft, second material can be reacted with phosgene followed by reaction with ammonia to produce the desired urea functional groups.

Epoxy functional groups may be obtained using either saturated or unsaturated fatty acids soft, second material described above. If an unsaturated fatty acid is used, reaction with peroxide will form internal epoxy groups. More preferably, an acid or hydroxyl functional soft, second material is reacted with epichlorohydrin. Cyclic carbonate functional groups may be made via carbon dioxide insertion into an epoxide group.

The soft, second material of the first embodiment may comprise a mixture of the following structures:

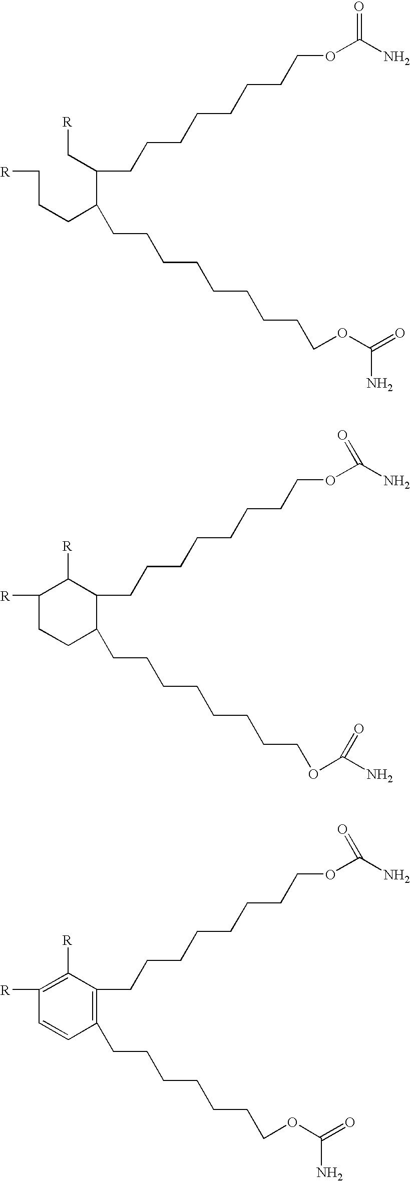

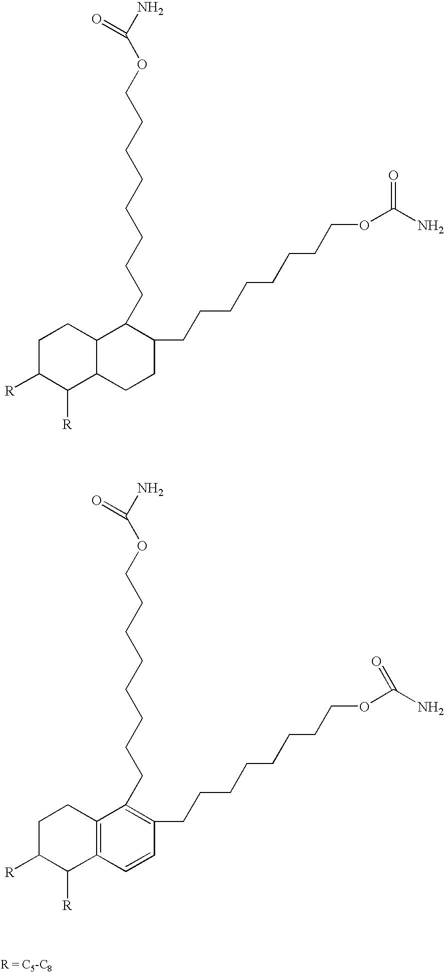

While the structures are shown with carbamate functional groups, other functional groups may be obtained as outlined above.

In a second embodiment, the second, soft material is a derivative of a mixture of fatty acid isomers and/or homologs in which two or more residues of the fatty reactants are joined by reaction with a polyfunctional reactant molecule, or a derivative of a mixture of epoxide esters of fatty acid isomers and/or homologs in which two or more residues of the fatty reactants are joined by reaction with a polyfunctional reactant molecule. Suitable fatty acid reactants include, without limitation, mixtures of linear and branched fatty acids having eight to fourteen carbon atoms, particularly mixtures of branched fatty acids such as neoalkanoic acid mixtures e.g., neodecanoic acid and/or the glycidyl esters these acids. A glycidyl ester of neodecanoic acid isomers is commercially available as Cardura E10 from Hexion. Fatty neoalkanoic acids may be represented by the general structure

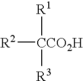

and epoxide esters of neoalkanoic acids may be represented by the general structure

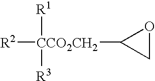

in which R¹, R², and R³ each is a hydrocarbyl radical and R¹, R², and R³ together have from six to twelve carbon atoms; preferably, at least one of R¹, R², and R³ is a methyl group.

In a first example of the second embodiment, the second, soft material comprises the reaction product of a glycidyl ester of a neoalkanoic acid mixture with a polycarboxylic acid. Nonlimiting examples of polycarboxylic acids include phthalic acid, isophthalic acid, terephthalic acid, thioglycolic acid, tricarballylic acid, azeleic acid, trimellitic anhydride, citric acid, malic acid, tartaric acid, citric acid, and adipic acid, as well as anhydrides of the acids.

The hydroxy group-containing product derived from the acid/epoxy ring-opening reaction may then be used as a hydroxyl-functional soft, second material, or the hydroxyl groups may be reacted to produce another functional group. In one example, the hydroxyl groups are reacted with cyanic acid and/or a compound comprising a carbamate group or a urea group in order to form a carbamate-functional soft, second material. Cyanic acid may be formed by the thermal decomposition of urea or by other methods, such as described in U.S. Pat. Nos. 4,389,386 or 4,364,913. When a compound comprising a carbamate or urea group is utilized, the reaction with the hydroxyl group is believed to be a transesterification between the hydroxyl group and the carbamate or urea group. The carbamate compound can be any compound having a carbamate group capable of undergoing a reaction (esterification) with a hydroxyl group. These include, for example, methyl carbamate, butyl carbamate, propyl carbamate, 2-ethylhexyl carbamate, cyclohexyl carbamate, phenyl carbamate, hydroxypropyl carbamate, hydroxyethyl carbamate, hydroxybutyl carbamate, and the like. Useful carbamate compounds can be characterized by the formula:

R′—O—(C═O)—NHR″

wherein R′ is substituted or unsubstituted alkyl (preferably of one to eight carbon atoms, more preferably of one to four carbon atoms) and R″ is H, substituted or unsubstituted alkyl (preferably of 1-8 carbon atoms, more preferably of one to four carbon atoms), substituted or unsubstituted cycloalkyl (preferably of 6-10 carbon atoms), or substituted or unsubstituted aryl (preferably of 6-10 carbon atoms). Preferably, R″ is H.

Urea groups can generally be characterized by the formula

R′—NR‘3(C═O)—NHR″

wherein R and R″ each independently represents H or alkyl, preferably of 1 to 4 carbon atoms, or R and R″ may together form a heterocyclic ring structure (e.g., where R and R″ form an ethylene bridge), and wherein R′ represents a substituted or unsubstituted alkyl (preferably of one to eight carbon atoms, more preferably of one to four carbon atoms).

The transesterification reaction between the carbamate or urea and the hydroxyl group-containing compounds can be conducted under typical transesterification conditions, for example temperatures from room temperature to 150° C., with transesterification catalysts such as calcium octoate, metal hydroxides, such as KOH, Group I or II metals, such as sodium and lithium, metal carbonates, such as potassium carbonate or magnesium carbonate, which may be enhanced by use in combination with crown ethers, metal oxides like dibutyltin oxide, metal alkoxides such as NaOCH₃ and Al(OC₃H₇)₃, metal esters like stannous octoate and calcium octoate, or protic acids such as H₂SO₄ or Ph₄SbI. The reaction may also be conducted at room temperature with a polymer-supported catalyst such as Amberlyst-15® (Rohm & Haas) as described by R. Anand, Synthetic Communications, 24(19), 2743-47 (1994), the disclosure of which is incorporated herein by reference.

The ring-opening of the oxirane ring of an epoxide compound by a carboxylic acid results in a hydroxy ester structure. Subsequent transesterification of the hydroxyl group on this structure by the carbamate compound results in a carbamate-functional component that can be represented by the structures:

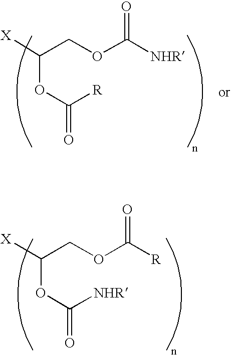

wherein n is a positive integer of at least 2, R′ represents H, alkyl, or cycloalkyl, R represents alkyl, aryl, or cycloalkyl, and X represents an organic radical that is a residue of the epoxide compound. As used herein, it should be understood that these alkyl, aryl, or cycloalkyl groups may be substituted. When the UV durability of the coating is desired, non-aromatic and saturated cyclic anhydrides are preferred.

Two different kinds of functional groups may be present on each molecule in this embodiment of the second, soft material. In one preferred embodiment, the reaction product of the epoxide-functional compound and the organic acid has a plurality of hydroxyl groups per compound and, on average, less than all of the hydroxyl groups are reacted with the cyanic acid or the compound comprising a carbamate or urea group. In a particularly preferred embodiment, the reaction product of the epoxide-functional compound and the organic acid has from about two to about four hydroxyl groups per molecule and only part of these groups, on average, are reacted to form a carbamate group or urea group on the compound of soft, second material. In another preferred embodiment, the precursor product of the reaction of the epoxide-functional compound with the organic acid has residual acid groups resulting from reaction of a stoichiometric excess of acid groups. The hydroxyl groups formed are then reacted with the cyanic acid or the compound comprising a carbamate or urea group to form a compound of component (a) having a carbamate or urea functionality as well as epoxide or acid functionality.

In another embodiment, the hydroxyl groups formed are retained to provide a hydroxyl-functional second, soft material. In another embodiment, the hydroxyl groups are reacted with a cyclic anhydride to provide a carboxyl-functional second, soft material. Epoxide groups may be obtained by using an ethylenically unsaturated epoxide-functional compound, and, following reaction with the organic acid, oxidizing the ethylene group with hydrogen peroxide. An embodiment with alkoxy silane functional groups is obtained by reaction with an epoxide-functional alkoxy silane compound, such as 2-(3,4-epoxycyclohexyl)ethyltrimethoxysilane or 3-glycydylpropyltrimethoxysilane.

In a second example of the second embodiment, the second, soft material is made by reacting together a diol with a cyclic anhydride to form a dicarboxylic acid having two internal ester groups, then reacting the dicarboxylic acid with a monoepoxide ester of the fatty acid(s). Optionally, hydroxyl groups from the epoxide reaction step are converted to carbamate groups or other functional groups.

In this second example, suitable nonlimiting diols include diols with 2-18 carbon atoms such as 1,3-propanediol, 1,2-ethanediol, 1,4-butanediol, 1,5-pentanediol, 1,6-hexanediol, dimethylolpropane, neopentyl glycol, 2-propyl-2-methyl-1,3-propanediol, 2-butyl-2-ethyl-1,3-propanediol, 2,2-diethyl-1,3-propanediol, 2,2,4-trimethylpentane-1,3-diol, trimethylhexane-1,6-diol, 2-methyl-1,3-propanediol, diethylene glycol, triethylene glycol, polyethylene glycols, dipropylene glycol, tripropylene glycol and polypropylene glycols. Cycloaliphatic diols such as cyclohexane dimethanol and cyclic formals of pentaerythritol such as, for instance, 1,3-dioxane-5,5-dimethanol can also be used. Aromatic diols, for instance 1,4-xylylene glycol and 1-phenyl-1,2-ethanediol, as well as reaction products of polyfunctional phenolic compounds and alyklene oxides or derivatives thereof, can furthermore be employed. Bisphenol A, hydroquinone, and resorcinol may also be used.

The diol is reacted with a cyclic anhydride. Suitable cyclic anhydrides include, without limitation, maleic anhydride, succinic anhydride, phthlalic anhydride, hexahydrophthalic anhydride, tetrahydrophthalic anhydride, methyl tetrahydrophthalic anhydride, methylhexahydrophthalic anhydride, trimellitic anhydride, adipic anhydride, glutaric anhydride, malonic anhydride, and the like. The anhydride may have non-reactive substituents, including alkyl groups.

The diol and the cyclic anhydride are preferably reacted in a molar ratio of about 1:1, so that a carboxyl group is generated from the anhydride in the reaction product for each hydroxyl group of the diol. This intermediate reaction product is then reacted with a mixture of monoepoxide esters of the fatty acid homologs and/or isomers, preferably with a mixture of glycidyl esters of neoalkanoic acids. The product is a hydroxyl-functional second, soft material.

The hydroxyl groups of the product may be converted to other functional groups, such as carbamate groups. A carbamate functional second, soft material of this second example may be prepared by reaction of the hydroxyl functional material just described with a low molecular weight carbamate functional monomer such as methyl carbamate under appropriate reaction conditions. Alternatively, carbamate groups can be formed by the decomposition of urea in the presence of the hydroxyl functional material. Finally, a carbamate functional second, soft material of this example can be obtained via the reaction of phosgene with the hydroxyl functional material just described, followed by reaction with ammonia.

Isocyanate functional groups may be obtained via reaction of the amine functional soft material with carbon dioxide or by half-capping a diisocyanate with the hydroxyl functional material.

Aminoplast functional groups may be made via reaction of carbamate or amide functional soft materials as described above with formaldehyde or aldehyde. The resulting reaction product may optionally be etherified with low boiling point alcohols such a methanol, ethanol, propanol, isopropanol, butanol, and isobutanol.

Urea functional groups may be made via reaction of an amine functional soft, second material with urea. Alternatively, amine functional soft, second material can be reacted with phosgene followed by reaction with ammonia to produce the desired urea functional groups.

Epoxide functional groups may be obtained by reaction of a carboxyl or hydroxyl functional second, soft material with epichlorohydrin. Cyclic carbonate functional groups may be made via carbon dioxide insertion into an epoxide group.

In a third example of the second embodiment, which is made with fatty acid, or an epoxide ester of a fatty acid, a polyepoxide compound is reacted with a mixture of the fatty acids as described above. Suitable polyepoxide compounds include, without limitation, diepoxides such as the diepoxide ester of decandiolic acid, triepoxides such as the triepoxide ester of cyclohexane tricarboxylic acid, and low molecular weight epoxide-functional oligomers such as epoxidized vegetable oils such as epoxidized soybean oil and epoxidized linseed oil. The reaction of the fatty acids with the epoxide groups of the polyepoxide produce beta-hydroxy ester groups.

Optionally, the hydroxyl groups from this reaction step are converted to other functional groups. Carbamate groups may be produced by reaction of the hydroxyl groups with a low molecular weight carbamate functional monomer such as methyl carbamate. Alternatively, carbamate groups may be made by decomposition of urea in the presence of the hydroxyl functional material. Finally, carbamate functional second, soft material can be obtained via the reaction of phosgene with the hydroxyl groups, followed by reaction with ammonia. Carboxyl groups may be generated by reaction of the hydroxyl groups with a cyclic anhydide, such as maleic anhydride. Epoxide groups may be generated by reaction of the acid- or hydroxy-functional material with epoxchlorohydrin. Cyclic carbonate functional groups may be made via carbon dioxide insertion into an epoxide group.

Amine functional groups may be obtained via reaction of the carboxyl-functional material to form an amide, followed by conversion to a nitrile and subsequent reduction to an amine. Isocyanate functional groups may be obtained via reaction of the amine functional soft material with carbon dioxide. Aminoplast functional groups may be made via reaction of carbamate or amide functional soft materials with formaldehyde or aldehyde. The resulting reaction product may optionally be etherified with low boiling point alcohols such a methanol, ethanol, propanol, isopropanol, butanol, and isobutanol.

Urea functional groups may be made via reaction of an amine functional soft, second material with urea. Alternatively, amine functional soft, second material can be reacted with phosgene followed by reaction with ammonia to produce the desired urea functional groups.

In a fourth example of the second embodiment of the soft, second material, a hydroxyalkyl carbamate compound is reacted with and a cyclic anhydride to prepare a compound having a carbamate group and a carboxylic acid group, then the carboxylic acid group is reacted with a mixture of fatty acid epoxy esters, such as a mixture of neoalkyl monoepoxides. This reaction produces hydroxyl groups, with may again optionally be converted to other functional groups such as carbamate groups, as outlined for the previous example. A carbamate group is also provided by the hydroxyalkyl carbamate.

In a fifth example of the second embodiment incorporating fatty acid moieties into a soft, second material, a di-cyclic carboxylic anhydride is reacted with a hydroxyalkyl carbamate compound to prepare a compound having two carbamate groups and two carboxylic acid groups, then reacting the compound having two carbamate groups and two carboxylic acid groups with a neoalkyl monoepoxide. Optionally, hydroxyl groups from the epoxide reaction step are converted to carbamate groups.

In a third embodiment of the second, soft material, the second, soft material is a hyperbranched, functional material prepared by a step of reacting an epoxy group with a carboxylic acid group and converting the resulting hydroxyl group to a carbamate group by one of the methods described already or known in the art. In particular, the hyperbranched functional material is a carbamate-functional resin having in its structure a hyperbranched or star polyol core, a first chain extension based on a polycarboxylic acid or cyclic anhydride, a second chain extension based on an epoxide-containing compound, and having carbamate functional groups on the core, the second chain extension, or both. Such a hyperbranched compound, then, has a residue of the polyol as its core, a residue of the polycarboxylic acid or cyclic anhydride as its first extension, and a residue of the epoxide as its next extension. Because each epoxide ring may open at the inner or the outer carbon, such a reaction product will be a mixture of isomers.

The carbamate-functional resin of the invention is based on a star or hyperbranched core and contains carbamate functionality. The carbamate functionality can be introduced onto the core by reacting the core with a compound containing a carbamate group and a functional group reactive with the hydroxyl groups on the core. Alternatively, it can be introduced by a series of extension steps with a polycarboxylic acid or anhydride and epoxy compound, followed by carbamoylation.

The star core is a structure based on a star polyol. A star polyol is a monomeric polyol containing three or more primary or secondary hydroxyl groups. In a preferred embodiment, the star polyol has four or more hydroxyl groups. Examples of star polyols include, without limitation, glycerol, trimethylolpropane, trimethylolethane, pentaerythritol, ditrimethylolpropane, dipentaerythritol, tetrakis (2-hydroxyethyl)methane, diglycerol, trimethylolethane, xylitol, glucitol, dulcitol, and sucrose. Mixtures of star polyols may also form the star core of the carbamate-functional resin of the invention.

A hyperbranched core is a structure based on hyperbranched polyols. Hyperbranched polyols are prepared by the reaction of a first compound having two or more hydroxyl groups and a second compound having one carboxyl group and two or more hydroxyl groups. The first and second compounds can be reacted to form a first generation hyperbranched polyol. Alternatively, the second compound can be reacted with the first generation hyperbranched polyol to form a second generation and, if desired, subsequent generations. Preferably, a first generation or second generation hyperbranched polyol is used as the hyperbranched core of the carbamate-functional resin.

The first compound can suitably be an aliphatic, a cycloaliphatic, or an aromatic diol, triol, or tetrol, a sugar alcohol such as sorbitol and mannitol, dipentaerythritol, an .alpha.-alkylglucoside such as .alpha.-methylglucoside, or an alkoxylate polymer having a molecular weight of at most about 8,000 that is produced by a reaction between an alkylene oxide or a derivative thereof and one or more hydroxyl groups from any of the alcohols mentioned above. Mixtures of these can also be used as the first compound.

Diols suitable as the first compound include straight diols with 2-18 carbon atoms. Examples include, without limitation, 1,3-propanediol, 1,2-ethanediol, 1,4-butanediol, 1,5-pentanediol, and 1,6-hexanediol.

The diols can also be branched such as, for instance, dimethylolpropane, neopentyl glycol, 2-propyl-2-methyl-1,3-propanediol, 2-butyl-2-ethyl-1,3-propanediol, 2,2-diethyl-1,3-propanediol, 2,2,4-trimethylpentane-1,3-diol, trimethylhexane-1,6-diol, and 2-methyl-1,3-propanediol. Other suitable diols include, without limitation, diethylene glycol, triethylene glycol, polyethylene glycols, dipropylene glycol, tripropylene glycol and polypropylene glycols.

Cycloaliphatic diols such as cyclohexane dimethanol and cyclic formals of pentaerythritol such as, for instance, 1,3-dioxane-5,5-dimethanol can also be used.

Aromatic diols, for instance 1,4-xylylene glycol and 1-phenyl-1,2-ethanediol, as well as reaction products of polyfunctional phenolic compounds and alyklene oxides or derivatives thereof, can furthermore be employed. Bisphenol A, hydroquinone, and resorcinol may also be used.

Diols of the ester type, for example neopentylhydroxypivalate, are also suitable diols.

As substitute for a 1,2-diol, the corresponding 1,2-epoxide or an α-olefin oxide can be used. Ethylene oxide, proplyene oxide, 1,2-butylene oxide, and styrene oxide can serve as examples of such compounds.

Suitable triols can contain three primary hydroxyl groups. Trimethylolpropane, trimethylolethane, trimethylobutane, and 3,5,5-trimethyl-2,2-dihydroxymethylhexane-1-ol are examples of this type of triols. Other suitable triols are those having two types of hydroxyl groups, primary as well as secondary hydroxyl groups, as for instance glycerol and 1,2,6-hexanetriol. It is also possible to use cycloaliphatic and aromatic triols and/or corresponding adducts with alkylene oxides or derivatives thereof.

Suitable tetrols for use as the first compound include, without limitation, pentaerythritol, ditrimethylolpropane, diglycerol and ditrimethylolethane. It is also possible to use cycloaliphatic and aromatic tetrols as well as corresponding adducts with alkylene oxides or derivatives thereof.

The second compound used to prepare the hyperbranched polyol can be a monofunctional carboxylic acid having at least two hydroxyl groups. Examples include, without limitation α,α-bis(hydroxymethyl)propionic acid (dimethylol propionic acid), α,α-bis(hydroxymethyl)butyric acid, α,α.α-tris(hydroxymethyl)acetic acid, .α,α-bis(hydroxymethyl)valeric acid, α,α-bis(hydroxyethyl)propionic acid or α-phenylcarboxylic acids having at least two hydroxyl groups directly pendant to the phenyl ring (phenolic hydroxyl groups) such as 3,5-dihydroxybenzoic acid.

The hyperbranched polyols can be prepared by reacting the first compound and second compound under esterification conditions. The temperature of reaction is generally from 0 to 300° C., preferably 50 to 280° C., and most preferably 100 to 250° C.

A first generation intermediate is prepared by reacting the first compound and second compound in an equivalent molar ratio of hydroxyls on the first compound to carboxyl groups on the second compound of between about 1:2 and about 2:1. Preferably the equivalent ratio will be from about 1:1.5 to about 1.5:1, and even more preferably from about 1:1.2 to about 1.2:1.

The functionality and polydispersity of the first generation intermediate, and of any subsequent generation, depend on the equivalent ratio of hydroxyl groups to carboxyl groups of the reactants in each step. The functionality of the hyperbranched polyol, whether first generation or subsequent generation, should be four hydroxyl groups or greater. Hyperbranched polyols with a wide range of polydispersities are useful. It is preferred that the polydispersity be less than about 2.5, preferably less than about 2.0, and most preferably less than about 1.8.

To make the resins of the invention, the core polyol, either star or hyperbranched as described above, is next reacted with a polycarboxylic acid or anhydride to form a first chain extension containing an ester linkage and a free carboxyl group. Preferred as the polycarboxylic acid or anhydride are cyclic carboxylic anhydrides. Anhydrides are advantageous for this step because the ring-opening esterification is faster than reaction of remaining hydroxyl groups on the core polyol with the carboxyl group liberated by the ring opening reaction. As a consequence the first chain extension is a half acid ester with little polymerization or polyester formation.

Suitable anhydrides include, without limitation, anhydrides of dicarboxylic acids with carboxyl groups on adjacent carbons. The anhydrides can be aliphatic, cycloaliphatic, or aromatic. Examples include without limitation, maleic anhydride, succinic anhydride, phthlalic anhydride, hexahydrophthalic anhydride, tetrahydrophthalic anhydride, methyl tetrahydrophthalic anhydride, methylhexahydrophthalic anhydride, and trimellitic anhydride. Other anhydrides useful in the invention include, without limitation, adipic anhydride, glutaric anhydride, malonic anhydride, and the like.

The reaction of the polycarboxylic acid or anhydride with the core polyol results in formation of a first intermediate that has carboxyl functionality and may contain some primary or secondary hydroxyl groups that result from any unreacted hydroxyl groups on the core polyol.

The stoichiometry is chosen so that at least one primary hydroxyl group of the core polyol reacts with the polycarboxylic acid or anhydride. Preferably at least two hydroxyl groups on the core polyol will be reacted. In some embodiments the molar ratio of hydroxyl on the core polyol to carboxyl group on the polycarboxylic acid or anhydride will be approximately 1:1, so that essentially every hydroxyl group on the core polyol is esterified.

The first intermediate, which contains at least one carboxyl group and optionally has primary or secondary hydroxyl groups as noted above, is next reacted with a compound containing an epoxide group to form a second intermediate having a chain extension based on a glycidyl ester of a neo-acid such as, without limitation, neodecanoic or neononanoic acid, or a glycidyl ester of a mixture of fatty acids, or a combinations of these.

The reaction of the epoxide compound with the first intermediate is preferably carried out without catalyst. In this case, the epoxide group of the epoxide-containing compound reacts faster with the carboxyl group than with any primary or secondary hydroxyl groups that may be present on the first intermediate. Therefore, a relatively clean chain extension is achieved to form a second intermediate that contains secondary hydroxyl groups resulting from ring opening of the epoxide, as well as any primary or secondary hydroxyl groups that remained unreacted in the formation of the first intermediate. Reaction conditions are selected to allow the epoxide group to open in either direction, resulting in a mixture of products, following reaction conditions known in the art.

Preferably the epoxy containing compound is reacted in a molar ratio of about 1:1 with respect to carboxyl groups on the first intermediate. However, if carboxyl groups are desired in the final product (for example for salting with amines to provide a water dispersible coating), an excess of carboxyl functional first intermediate may be used.

Techniques for adding carbamate groups to the second intermediate have already been described. For example, a carbamate group may be added to the second intermediate by reacting the second intermediate with phosgene and then ammonia to form a compound having primary carbamate groups, or by reaction of the second intermediate with phosgene and then a primary amine to form a compound having secondary carbamate groups. Alternatively, the second intermediate may be reacted with one or more ureas to form a compound with secondary carbamate groups (i.e., N-alkyl carbamates). This reaction is accomplished by heating a mixture of the second intermediate and urea. Another technique is the reaction of the second intermediate with a monoisocyanate, for example methylisocyanate, to form a compound with secondary carbamate groups. In another example, the second intermediate can be reacted with cyanic acid formed by the thermal decomposition of urea, or reacted with a compound having a carbamate group capable of undergoing a transesterification with the hydroxyl groups on the second intermediate. These include, without limitation, methyl carbamate, butyl carbamate, propyl carbamate, 2-ethylhexyl carbamate, cyclohexyl carbamate, phenyl carbamate, hydroxypropyl carbamate, hydroxyethyl carbamate, and the like. The transesterification reaction between the second intermediate and the carbamate compound can be conducted under typical transesterification conditions, as described above.

In another embodiment, the carbamate compound comprises a molecule with an isocyanate group and a carbamate group. Such a molecule can be prepared for example by reacting an organic diisocyanate with a difunctional compound that contains, in addition to a carbamate group, a reactive hydroxyl or amino group. The difunctional molecule can be, for example, a hydroxycarbamate that is the reaction product of ammonia or a primary amine with an alkylene carbonate.

Diisocyanates suitable for reaction with the difunctional compound to form the carbamate compound include aliphatic or cycloaliphatic diisocyanates, such as 1,11-diisocyanatoundecane, 1,12-diisocyanatododecane, 2,2,4- and 2,4,4-trimethyl-1,6-diisocyanatohexane, 1,3-diisocyanatocyclobutane, 4,4′-bis-(isocyanatocyclohexyl)methane, hexamethylene diisocyanate (HMDI), 1,2-bis-(isocyanatomethyl)cyclobutane, 1,3- and 1,4-bis-(isocyanatomethyl)cyclohexane, hexahydro-2,4- and/or -2,6-diisocyanatotoluene, 1-isocyanato-2-isocyanatomethyl cyclopentane, 1-isocyanato-3-isocyanatomethyl-3,5,5-trimethyl-cyclohexane, 2,4′-dicyclohexylmethane diisocyanate, and 1-isocyanato-4(3)-isocyanatomethyl-1-methyl cyclohexane.

Other suitable diisocyanates include aromatic diisocyanates, such as, without limitation, tetramethyl-1,3- and/or -1,4-xylylene diisocyanate, 1,3- and/or 1,4-phenylene diisocyanate, 2,4- and/or 2,6-toluene diisocyanate, 2,4- and/or 4,4′-diphenyl-methane diisocyanate, 1,5-diisocyanato naphthalene, p-xylylene diisocyanate and mixtures of these.

Suitable diisocyanates are also understood to include those containing modification groups such as biuret, uretdione, isocyanurate, allophanate and/or carbodiimide groups, as long as they contain two isocyanate groups.

The carbamate compound can be prepared by converting one of the isocyanate groups of the diisocyanate to a carbamate group by reacting the diisocyanate with the difunctional compound. To make it easier to convert just one isocyanate group, it is preferred to use a diisocyanate compound that has isocyanate groups of different reactivity. In this situation, one of the isocyanates will react preferentially with the difunctional compound.

Examples of diisocyanates having isocyanate groups of different reactivity include, without limitation, 1-isocyanato-3-isocyanatomethyl-3,5,5-trimethylcyclohexane (also known as isophorone diisocyanate), 1-isocyanato-2-isocyanatomethylcyclopentane, 1-isocyanato-1-methyl-4(3)-isocyanatomethylcyclohexane, 2,3-toluenediisocyanate, and 2,4-toluenediisocyanate. In a preferred embodiment, isophorone diisocyanate is used.

The product of such a reaction is a compound with an isocyanate group and a carbamate group. As an illustration, when the diisocyanate is isophorone diisocyanate, and the difunctional molecule is a reaction product of ammonia and propylene carbonate, one isomer of the carbamate compound can be represented by the idealized structure

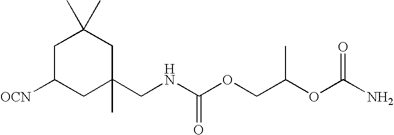

The idealized structure illustrates the preferential reaction of the difunctional compound with the primary isocyanate on isophorone diisocyanate. The actual product of such a reaction statistically will include some product substituted on the secondary isocyanate, as well as disubstitued diisocyanate and some unreacted diisocyanate. The product can then be reacted with the second intermediate to provide the resin of the invention.

The hyperbranched material can contain carbamate groups on the core, on the second chain extension, or both. It follows from the discussion above that any carbamate groups on the core will be attached to primary or secondary hydroxyl carbamate groups, while any carbamate groups on the second chain extension will be attached to secondary hydroxyl groups.

In one embodiment, the presence of at least some free hydroxyl groups on the carbamate-functional resin is preferred to increase intercoat adhesion by allowing for hydrogen bonding. For example, all or a portion of the primary hydroxyl groups on the second intermediate may be selectively carbamoylated, leaving unsubstituted secondary hydroxyl groups on the resin of the invention. The reaction rate of a primary hydroxyl group with the carbamate compound is greater than that of a secondary hydroxyl group. Selective carbamoylation of the primary groups is straightforward because the carbamate compound reacts preferentially with the primary hydroxyl group.

On the other hand, in another embodiment, all of the available hydroxyl groups on the second intermediate are converted to carbamate groups. This is desirable when greater crosslinking density is desired in the resin.

As another example, a carbamate-functional resin can be prepared by direct carbamoylation of the core polyol itself. The primary hydroxyl groups of the core may be converted to carbamate functionality by any of the techniques noted above. To make the resin soluble in organic solvents, it is preferred that at least one of the primary hydroxyl groups on the core polyol be converted by reaction with a second compound having an isocyanate group and a carbamate group. Such compounds are prepared from organic diisocyanates as discussed above. Preferably, most or all of the primary or secondary hydroxyl groups on the core polyol are reacted with the second molecule to form a highly carbamate-functional resin.

In a non-limiting example, a hyperbranched core polyol is made by reacting trimethylolpropane and dimethylol propionic acid in a 1:3 molar ratio such that there are equal equivalents of hydroxyl groups on the trimethylolpropane to carboxyl groups on the dimethylolpropionic acid. A core polyol results that has six primary hydroxyl groups. The core polyol is reacted with a carbamate-functional isocyanate molecule, which is in turn prepared by the reaction of isophorone diisocyanate with a hydroxy carbamate.

In a third embodiment, the second, soft material is prepared by a process that involves a step of reacting together a lactone or a hydroxy carboxylic acid and a compound comprising a carbamate or urea group or a group that can be converted to a carbamate or urea group and a group that is reactive with the lactone or hydroxy carboxylic acid. In the case of a group that can be converted to a carbamate or urea group, the group is converted to the carbamate or urea group either during or after the reaction with the lactone or hydroxy carboxylic acid. The process for preparing the third embodiment of the second, soft material may include a further step in which a hydroxyl-functional product of the first step is reacted with a compound having at least two isocyanate groups.

In yet another embodiment, the second, soft material may also contain a mixture of compounds prepared according to Rink et al., U.S. Pat. No. 6,878,841. For example, at least one of a) a mixture of diethyloctanediol dicarbamates with ethyl groups have a mixture of substitution patterns and b) a mixture of diethyloctanediol diallophanates Such compounds may be prepared from diethyloctanediol. With regard to the two ethyl groups, the linear eight-carbon chain of diethyloctanediol may have the following substitution patterns: 2,3; 2,4; 2,5; 2,6; 2,7; 3,4; 3,4; 3,6; and 4,5. With regard to the two hydroxyl groups, the linear eight-carbon chain may have the following substitution patterns: 1,2; 1,3; 1,4; 1,5; 1,6; 1,7; 1,8; 2,3; 2,4; 2,5; 2,6; 2,7; 2,8; 3,4; 3,5; 3,6; 3,7; 3,8; 4,5; 4,6; 4,7; 4,8; 5,6; 5,7; 5,8; 6,7; 6,8; or 7,8. The substitution patterns of the two ethyl groups and the two hydroxyl groups may be combined with one another in any desired way. Examples of the substitution patterns for the diethyloctanediol reactant are set out in Rink et al., U.S. Pat. No. 6,878,841.

The diethyloctanediol reactant can be purchased commercially (for example, as by-products of 2-ethylhexanol synthesis) or prepared by known synthesis methods, such as base-catalyzed aldol condensation.

A mixture of diethyloctanedicarbamate isomers can be prepared from a mixture of diethyloctanediol isomers by reaction with alkyl, cycloalkyl, or aryl carbamates, such as methyl carbamate, butyl carbamate, cyclohexyl carbamate, or phenyl carbamate, to generate the diethyloctanedicarbamates and alcohol by-product. The by-products may be removed by usual methods, such as vacuum distillation. In an alternative synthesis, the mixture of diethyloctanediols can be reacted with phosgene and then with ammonia (to form a primary carbamate group) or a primary amine (to form a secondary carbamate group).

A mixture of diethyloctanediol allophanate isomers can be prepared from a mixture of diethyloctanediol isomers by reaction with alkyl, cycloalkyl, or aryl allophanates, such as methyl allophanate or ethyl allophanate. This reaction may be carried out at reaction temperatures of 50-150° C., with removal of by-product alcohol, such as with distillation under a vacuum, and in the presence of an acid catalyst such as para-toluene sulfonic acid.

Coating compositions of the invention also comprise at least one crosslinking agent that is reactive with the functional groups of the first, hard material and the functional groups of the second, soft material. Illustrative examples of crosslinking agents are those having a plurality of crosslinkable functional groups reactive with the first, hard material and the second, soft material. Such functional groups include, for example, aminoplast, hydroxy, isocyanate, amine, epoxy, acrylate, vinyl, silane, and acetoacetate groups. These groups may be masked or blocked in such a way so that they are unblocked and available for the cross-linking reaction under the desired curing conditions, generally elevated temperatures. Useful crosslinkable functional groups include hydroxy, epoxy, acid, anhydride, silane, activated methylene and acetoacetate groups. Preferred crosslinking agents will have crosslinkable functional groups that include hydroxy functional groups and amino functional groups and isocyanate groups. Di- and/or polyisocyanates and/or aminoplast resins are most preferred for use as crosslinking agents in coating compositions comprising the mixture (II) of the invention. Mixed crosslinkers may also be used.

The crosslinking agent can be used in amounts of from 1 to 90%, preferably from 3 to 75%, and more preferably from 25 to 50%, all based on the total fixed vehicle (film-forming materials) of the coating composition.

In one exemplary embodiment, the crosslinker or at least one crosslinker if the coating composition contains a plurality of crosslinkers will have functional groups that will react with the functional groups of the first, hard material to form a crosslink that is non-reversible under cure conditions. This will help to insure that the reactive additive remains crosslinked in the film. Some non-limiting examples of crosslinkable functional groups pairs that fall under this category are: carbamate:aminoplast, hydroxy:epoxy, and hydroxy:isocyanate. An example of a crosslink that is reversible under cure conditions is hydroxy:aminoplast, and hydroxy: activated methylene.

For example, when the first, hard material and/or the second, soft material comprise hydroxy functional groups, the crosslinking agent may be selected from the group of aminoplast resins, polyisocyanate and blocked polyisocyanate resins (including an isocyanurates, biurets, or reaction products of a diisocyanate and a polyol having less than twenty carbon atoms), polyepoxides, carboxyl or anhydride functional crosslinking agents, and mixtures thereof. When the second, soft material is hydroxyl functional, the crosslinker or at least one crosslinker if the coating composition contains a plurality of crosslinkers most preferably will be isocyanate groups, whether blocked or unblocked.

Illustrative examples of polyepoxide crosslinking components are polyepoxides such as glycidyl esters and ethers of polyols and polycarboxylic acids such as those mentioned above, glycidyl methacrylate polymers and isocyanurate containing epoxide functional polymers such as triglycidyl isocyanurate and the reaction product of glycidol with an isocyanate functional isocyanurate such as the trimer of isophorone diisocyanate (IPDI).

Illustrative examples of isocyanate functional crosslinking agents (c) are all known isocyanate functional polymers and oligomers. Preferred isocyanate functional crosslinking agents are isocyanate functional vinyl polymers such as isocyanatoethyl (meth)acrylate polymers, particularly those of two molecular weight, and the trimers of diisocyanates such as IPDI and hexamethylene diisocyanate (HDI), which may be blocked or unblocked.

When the functional groups of either the first, hard material or the second, soft material are carboxyl, the crosslinking agent will most preferably be a polyepoxide as described above.

When the functional groups of either either the first, hard material or the second, soft material are carbamate, the crosslinking agent may be selected from the group consisting of aminoplast resins, aldehydes, and mixtures thereof. Most preferably, when the functional groups of either the first, hard material or the second, soft material are carbamate, the crosslinking agent will be aminoplast resin. Alternatively, if thermally reversible linkages are sufficient in the case of the first, hard material, the crosslinking agent may be a polyisocyanate. In this case, the resulting link is an allophanate that can be made to be reversible during the cure schedule when Lewis acid catalysts such as dibutyl tin diacetate are used.

Illustrative examples of suitable aminoplast resins are melamine formaldehyde resins (including monomeric or polymeric melamine resin and partially or fully alkylated melamine resin), urea resins (e.g., methylol ureas such as urea formaldehyde resin, alkoxy ureas such as butylated urea formaldehyde resin), and carbamate formaldehyde resins.

When the functional groups of anti-popping component (a) and/or a film-forming component (b) are epoxy, functional groups (iii) may be carboxyl or hydroxyl, or mixtures thereof, carboxyl being most preferred. Illustrative examples of carboxyl functional crosslinking components (c) are acid functional acrylics, acid functional polyesters, acid functional polyurethanes, and the reaction products of polyols such as trimethylol propane with cyclic anhydrides such as hexahydrophthalic anhydride.

When the functional groups of anti-popping component (a) and/or a film-forming component (b) are cyclic carbonate, functional groups (iii) should be amine if a thermally irreversible linkage is desired. An illustrative example of an amine functional crosslinking component (c) is triaminononane. Anther example is the reaction product of a hydroxy ketamine resin which may be formed, for example, by the reaction of a hydroxy ketamine with an isocyanate functional material, oligomers or polymer.

Similarly, when the functional groups are amine, functional groups (iii) should be cyclic carbonate, isocyanate functional as described above, or mixtures thereof in order to obtain thermally irreversible linkages.

Cyclic carbonate functional crosslinking agents may be obtained by the reaction product of carbon dioxide with any of the above described epoxy functional crosslinking agents. Alternatively, a cyclic carbonate functional monomer may be obtained by the reaction of carbon dioxide with an epoxy functional monomer such as glycidyl methacrylate or glycidol, followed by polymerization/oligomerization of the cyclic carbonate functional monomer. Additional methods of obtaining cyclic carbonate functional crosslinking agents are known in the art and may be used.

When the functional groups are isocyanate, functional groups (iii) may be hydroxy, amine or mixtures thereof in order to obtain thermally irreversible linkages, hydroxy being most preferred. Hydroxy functional crosslinking components (c) are polyols, hydroxy functional acrylics, hydroxy functional polyesters, hydroxy functional polyurethanes, hydroxy functional isocyanurates and mixtures thereof as are known in the art.

Examples of functional groups that are reactive with each other and result in thermally reversible bonds are well known in the art. Illustrative examples are the reaction of aminoplasts with polyols, the reaction of cyclic anhydrides with polyols, and the reaction of activated secondary carbarnates such as TACT with hydroxy groups. Suitable examples of the individual components are discussed above and may be selected accordingly.

The coating composition used in the method of the invention may include a catalyst to enhance the cure reactions between anti-popping component (a), film-forming components (b) and crosslinking agent (c). For example, when aminoplast compounds, especially monomeric melamines, are used as crosslinking agents (c), a strong acid catalyst may be utilized to enhance the cure reaction. Such catalysts are well known in the art and include, without limitation, p-toluenesulfonic acid, dinonylnaphthalene disulfonic acid, dodecylbenzenesulfonic acid, phenyl acid phosphate, monobutyl maleate, butyl phosphate, and hydroxy phosphate ester. Strong acid catalysts are often blocked, e.g. with an amine. Other catalysts that may be useful in the composition of the invention include Lewis acids, zinc salts, and tin salts.

Additional agents, for example surfactants, fillers, stabilizers, wetting agents, dispersing agents, adhesion promoters, UV absorbers, hindered amine light stabilizers, etc. may be incorporated into the coating compositions used in the method of the invention. While such additives are well known in the prior art, the amount used must be controlled to avoid adversely affecting the coating characteristics.

The method of the invention may be used with coating compositions that function as primers, basecoats, topcoats, and/or clearcoats. Suitable coating compositions may be one, two or multicomponent coating compositions and may be in the form of powder coating compositions, powder slurry coating compositions, waterborne coatings/aqueous dispersions, or solvent borne coating compositions.

Illustrative powder coatings suitable for application in the method of the invention are those having the anti-popping component (a), a film-forming component (b) and a crosslinking component (c) as discussed above. In general, powder coatings suitable for use in the method of the invention may be prepared by processing a mixture of components (a), (b) and (c) by accepted powder compound manufacturing technology, for example via sheet, roll or drop techniques. After solidifying, the mixture is broken into particles having a desired size and shape. The average size and shape of the compound particles is dependent upon handling, processing, and equipment considerations.

Preferably, the compound will be in the shape of spheres, flat chips or discs having regular or irregular dimensions. Particles having an average particle size of from about 0.1 to 100 microns are suitable, with average particle sizes of from 1 to 75 microns preferred, with average particle sizes of from 15 to 45 microns most preferred. Particle size as used herein refers to the average diameter of an object having irregular boundaries that can be determined with known test methods.

Powder slurry compositions suitable for use in the method of the invention may be made by dispersing a solid particulate component in a liquid component. The solid particulate component may be a powder coating composition as described above or alternatively may be a solid particulate component comprising one or more of anti-popping component (a), film-forming component (b), and crosslinking component (c). The liquid component may be water, water soluble solvents, liquid crosslinking components and mixtures thereof. Illustrative liquid crosslinking components include liquid aminoplast resins.

During the preparation of suitable powder slurry compositions, the components may be combined and mixed well by conventional processes. A grinding or milling operation may follow such admixture. A preferred method of manufacture is disclosed in U.S. Pat. No. 5,379,947, hereby incorporated by reference. Powder slurry compositions can be applied by spray or by electrostatic deposition.

Illustrative waterborne coatings suitable for use in the claimed method will generally contain aqueous dispersions of organic binder components comprising anti-popping component (a) and optionally one or more of film-forming components (b) and/or crosslinking component (c). The dispersion of these components into water may occur with chemical aids, i.e., ionic and/or nonionic surfactants, dispersing and/or stabilizing resins; mechanical means via the high stress and/or high shear equipment such as microfluidizers and combinations thereof.

Illustrative ionic surfactants include ionic or amphoteric surfactants such as sodium lauryl sulfate. An example of a suitable commercially available ionic surfactant is ABEX EP 110 from Rhodia of Cranbury, N.J.

Illustrative nonionic surfactants include nonionic surfactants based on polyethoxylated alcohols or polyethoxy-polyalkoxy block copolymers, polyoxyethylenenonylphenyl ethers, polyoxyethylenealkylallyl ether sulfuric acid esters and the like.

Mechanical means such as high stress techniques can also be used to prepare suitable aqueous dispersions. Alternative modes of applying stress to a mixture of water and organic binder component can be utilized so long as sufficient stress is applied to achieve the requisite particle size distribution. For example, one alternative manner of applying stress would be the use of ultrasonic energy.

A preferred high stress technique for preparing aqueous dispersions uses a MICROFLUIDIZER.RTM. emulsifier, available from Microfluidics Corporation in Newton, Mass. The MICROFLUIDIZER® high-pressure impingement emulsifier is patented in U.S. Pat. No. 4,533,254. The device consists of a high-pressure (up to 25,000 psi) pump and an interaction chamber where the emulsification takes place. Generally, the mixture of organic binder component and water is passed through the emulsifier once at a pressure between 5,000 and 15,000 psi. Multiple passes can result in smaller average particle size and a narrower range for the particle size distribution.

Mechanical means such as high stress techniques may also be combined with the chemical dispersion aids such the surfactants such as discussed above or the stabilizing and/or dispersing resins discussed below. Most preferably, the high stress techniques will be combined with suitable chemical aids, especially stabilizing resins and/or dispersing resins.

Illustrative examples of suitable dispersing and/or stabilizing resins or polymers are the hydroxyl-containing emulsifiers taught in U.S. Pat. No. 6,309,710 and various nonpolyalkoxylated stabilizing resins.

Suitable hydroxyl-containing emulsifiers are preferably diols and/or polyols having emulsifying properties, with particular preference diols and/or polyols having a molecular weight of between 500 and 50,000 daltons; with very particular preference, having a molecular weight of between 500 and 10,000 daltons and, in particular, from 500 to 5000 daltons. The emulsifying diols and/or polyols are preferably selected from the group of the polyacrylate-diols and/or -polyols, polyester-diols and/or -polyols and polyether-diols and/or -polyols, and, with very particular preference, from the group of the polyurethane-diols and/or -polyols, polycarbonate-diols and/or -polyols, and polyether-diols and/or polyols.

The ratio of hydrophilic to hydrophobic moieties in the diols and/or polyols is preferably established either by way of the molecular weight of the diols and/or polyols and the fraction of hydrophilic groups already present in the diol and/or polyol, or by the introduction of additional hydrophilic groups, such as acid groups or salts thereof, examples being carboxyl or carboxylate groups, sulfonic acid or sulfonate groups, and phosphonic acid or phosphonate groups.

Particularly preferred polyether-diols and/or -polyols are block copolyethers consisting of ethylene oxide and propylene oxide units, the proportion of ethylene oxide units being from 30 to 50% and the proportion of propylene oxide units being from 50 to 70% by weight. The molecular weight is preferably around 9000 daltons. Emulsifiers of this kind are sold, for example, by BASF AG under the trade name Pluronic® PE 9400.

A particularly preferred stabilizing resin is an acrylic copolymer having a plurality of functional groups that impart water dispersibility. Such stabilizing resins are the free radical polymerization product of one or more hydrophobic ethylenically unsaturated monomers and one or more hydrophilic ethylenically unsaturated monomers, such monomers being used in an appropriate ratio so as to achieve the desired degree of stabilization. It will be appreciated that the plurality of stabilizing or water dispersible functional groups will typically be incorporated into the copolymer via the polymerization of the hydrophilic monomers.

Most preferred stabilizing resins will normally have a number average molecular weight of from 5000 to 50,000, preferably from 10,000 to 25,000, with molecular weights of from 15,000 to 20,000 being most preferred. Most preferred stabilizing resins will further have an acid number of from 40 to 60, preferably 42 to 52, and most preferably 44 to 48.

The functional groups that impart water dispersibility or stability to the stabilizing resin can be anionic, cationic, or nonionic. Anionic and nonionic groups are most preferred because of the tendency of the cationic groups, (i.e., amine) groups to cause yellowing in any final cured coating.

Suitable hydrophobic ethylenically unsaturated monomers are vinyl esters, vinyl ethers, vinyl ketones, aromatic or heterocyclic aliphatic vinyl compounds, and alkyl esters having more than 4 carbon atoms of alpha, beta-ethylenically unsaturated mono- or dicarboxylic acids containing 3 to 5 carbons. Preferred are the aromatic or heterocyclic aliphatic vinyl compounds and the C4 or greater alkyl esters of alpha, beta-unsaturated monocarboxylic acids such as acrylic or methacrylic acid.

Representative examples of suitable esters of acrylic, methacrylic, and crotonic acids include, without limitation, those esters from reaction with saturated aliphatic and cycloaliphatic alcohols containing from 4 to 20 carbon atoms, such as n-butyl, isobutyl, tert-butyl, 2-ethylhexyl, lauryl, stearyl, cyclohexyl, trimethylcyclohexyl, tetrahydrofurfuryl, stearyl, and sulfoethyl. Preferred are alkyl esters of from 4 to 12 carbon atoms, with alkyl esters of from 4 to 10 carbon atoms being most preferred. 2-ethylhexyl acrylate is especially preferred.

Representative examples of aromatic or heterocyclic aliphatic vinyl compounds include, without limitation, such compounds as styrene, alpha-methyl styrene, vinyl toluene, tert-butyl styrene, and 2-vinyl pyrrolidone. Styrene is a most preferred example.

Most preferred hydrophobic monomers for use in making stabilizing resins for use in waterborne coating compositions for use in the method of the invention are styrene, ethylhexyl acrylate, and butyl methacrylate.

Suitable hydrophilic ethylenically unsaturated monomers are those that act to stabilize both the stabilizing resin and organic binder component in the aqueous dispersion. Illustrative examples are low molecular weight alkyl acrylate esters that allow hydrogen bonding, weak hydrogen bond donors, strong hydrogen bond donors, and hydrogen bond acceptors based on polyethers.

For example, low molecular weight alkyl esters of alpha, beta-ethylenically unsaturated monocarboxylic acids having alkyl groups of less than three carbons may be used as the hydrophilic monomers. Representative examples include the esters of acrylic and methacrylic acid with saturated aliphatic alcohols of three or less carbons atoms, i.e., methyl, ethyl, and propyl.

Suitable weak hydrogen bond donors are those ethylenically unsaturated monomers having functional groups such as hydroxyl, carbamate, and amide. Carbamate functional ethylenically unsaturated monomers may also be used. Hydroxyl functional ethylenically unsaturated monomers such as hydroxyalkyl acrylates and methacrylates are also suitable. Representative examples include, without limitation, hydroxy ethyl acrylate, hydroxyethyl methacrylate, and the like. Also suitable are acrylic and methacrylic acid amides and aminoalkyl amides, acrylonitrile and methacrylonitrile.

Strong hydrogen bond donors such as strong acids are also suitable for use as the hydrophilic monomers. Useful ethylenically unsaturated acids include alpha,beta-olefinically unsaturated monocarboxylic acids containing 3 to 5 carbon atoms, alpha,beta-olefinically unsaturated dicarboxylic acids containing 4 to 6 carbon atoms and their anhydrides, unsaturated sulfonic acids, and unsaturated phosphonic acids. Representative examples include, without limitation, acrylic acid, methacrylic acid, crotonic acid, fumaric acid, maleic acid, itaconic acid and their respective anhydrides. Acrylic and methacrylic acid are most preferred.

Polyether based hydrogen bond acceptors may also be used in the most preferred stabilizing resin. Useful ethylenically unsaturated polyethers include ethylene oxide and the alkoxy poly(oxyalkylene) alcohol esters or amides of alpha,beta-olefinically unsaturated monocarboxylic acids containing 3 to 5 carbon atoms. The alkoxy poly(oxyalkylene) alcohol or alkoxy poly(oxyalkylene) amine employed in forming the monomer can be obtained by the alkoxylation of monohydric alcohols with ethylene oxide or mixtures of ethylene oxide with other epoxides of up to ten carbon atoms, such as propylene oxide or butylene oxide.

The residue of the alkoxy poly(oxyalkylene) alcohol or amine contained in an acrylic polymer suitable as the most preferred stabilizing resin can be represented by D(CH(R₁)CH₂O—)ₙR₂, and is either alkoxy polyoxyethylene or an alkoxy polyoxyethylene/polyoxyalkylene copolymer, having a degree of polymerization of n, n being an integer from one to one thousand. D is 0 in the case of the alkoxy poly(oxyalkylene) alcohol and NH in the case of the amine. Preferably, n is an integer from 20 to 200; more preferably, from 40 to 70. R₁ is thus either hydrogen or a mixture of hydrogen and alkyls of one to eight carbon atoms. It is particularly advantageous for R₁ to be either hydrogen or a mixture of hydrogen and alkyls of one to three carbon atoms. R₂ is an alkyl of one to thirty carbon atoms. R₂ is preferably an alkyl of one to ten carbon atoms. In one embodiment, R₁ can be hydrogen and R₂ can be methyl.

Preferably, the hydrophilic monomers used to make suitable stabilizing resins will have functional groups selected from the group consisting of carboxylic acid groups, hydroxyl groups, oxirane groups, amide groups, and mixtures thereof. Most preferably, hydrophilic monomers having a mixture of acid groups, hydroxyl groups, and carbamate groups will be used. However, hydrophilic monomers having carboxylic acid groups will preferably be minimized as much as possible to avoid negative effects in finished film properties. Most preferred hydrophilic monomers are acrylic acid, hydroxy ethyl acrylate and hydroxy ethyl methacrylate.

In a preferred embodiment, the method of the invention will involve the application of waterborne, solvent borne or powder coating compositions. In a most preferred embodiment, the applied coating composition will be a waterborne coating composition.

The method of the invention can be used to provide cured coating films wherein the applied coating compositions are high-gloss coatings and/or clearcoats of composite color-plus-clear coatings. High-gloss coatings may be described as those coatings which provide cured coating films having a 200 gloss or more (ASTM D523-89) or a DOI (ASTM E430-91) of at least 80.

Notwithstanding the preference for using the coating compositions in making clearcoats composite color-plus-clear systems, the coating compositions may also be used to make cured coating films wherein the applied coating composition is a basecoat or a high-gloss pigmented paint coating. In this case, the coating composition used in the method of the invention may comprise one or more pigments such as any organic or inorganic compounds or colored materials, fillers, metallic or other inorganic flake materials such as mica or aluminum flake, and other materials of the kind that the art normally includes in such coatings. Pigments and other insoluble particulate compounds such as fillers are usually used in the composition in an amount of 1% to 100%, based on the total solid weight of binder component (a) and crosslinking component (c) and any other film-forming components. (i.e., a pigment-to-binder ratio of 0.1 to 1).

The method of the invention requires the application of a coating composition to a substrate. Suitable substrates may be any surface capable of being coated and subjected to conditions sufficient to effect curing of the applied coating. Especially suitable substrates are those typically encountered in the transportation/automotive industries. Illustrative examples include metal substrates such as steel, aluminum, and various alloys, flexible plastics, rigid plastics and plastic composites. Metal substrates and rigid plastic substrates are preferred.

Suitable substrates may or may not have been coated prior to the use of the method of the invention. Illustrative examples include electrocoated substrates, primed substrates, basecoated substrates, and mixtures thereof. In a preferred embodiment, the substrate used in the method of the invention will have a coated film applied to a substrate such as described above. The coated film on the substrate may be a cured or uncured coating film. In a preferred embodiment, the substrate to be used in the method of the invention will be an uncured, previously applied coating film, most preferably a substrate coated with an uncured pigmented basecoat that is part of a composite color-plus-clear coating system. In this most preferred embodiment, the coating composition to be applied as part of the method of the invention will be a clearcoat coating composition. The clearcoat coating composition of the invention may be applied with excellent results over layers of waterborne basecoat compositions or solventborne basecoat compositions, and may be applied in methods in use in automotive assembly and trim plants.

In this most preferred embodiment, the uncured coated film over which the clearcoat coating composition is applied over may be any pigmented basecoat composition such as are known in the art, and does not require explanation in detail herein. Polymers known in the art to be useful in basecoat compositions include acrylics, vinyls, polyurethanes, polycarbonates, polyesters, alkyds, and polysiloxanes. Preferred polymers include acrylics and polyurethanes. In one preferred embodiment of the invention, the basecoat composition also utilizes a carbamate-functional acrylic polymer. Basecoat polymers may be thermoplastic, but are preferably crosslinkable and comprise one or more type of crosslinkable functional groups. Such groups include, for example, hydroxy, isocyanate, amine, epoxy, acrylate, vinyl, silane, and acetoacetate groups. These groups may be masked or blocked in such a way so that they are unblocked and available for the crosslinking reaction under the desired curing conditions, generally elevated temperatures. Useful crosslinkable functional groups include hydroxy, epoxy, acid, anhydride, silane, and acetoacetate groups. Preferred crosslinkable functional groups include hydroxy functional groups and amino functional groups. Pigmented basecoats serving as the substrate in the method of the invention may comprise pigments such as those discussed above with regards to pigmented coating compositions used in the method of the invention.

The method of the invention requires that the coating composition be applied in an amount such that a cured coating film of at least 2.0 mils/50.8 microns results. In general, liquid coatings intended for use in the automotive OEM applications have a finished film build goal in the range of from at least 1.3 mils/33.0 microns, more particularly from 1.3 to 3.0 mils/33.0 to 76.2 microns, and most preferably from 1.3 to 2.0 mils/33.0 to 50.8 microns. However, application inconsistencies often result in fatty or thick edges, and heavy film builds greater than 2.0 mils/50.8 microns the cured film. Thus, the method of the invention is therefore intended to provide greater pop tolerance at cured film builds of at least 2.0 mils/50.8 microns, more preferably at cured film builds of at least 2.5 mils/63.5 microns, and most preferably at cured film builds of at least 3.0 mils/76.2 microns.

In general, the curable coating composition will have a % NV (nonvolatile by weight) of from 55% to 100%, preferably 70% to 100%, with organic liquid coatings generally having a % NV of from 70 to 90% and powder coatings having a % NV of approximately 100%. Thus, in the method of the invention the curable coating composition will generally be applied so as to result in an uncured coating film of from about 2.6 to 6.0 mils/66.0 to 152.4 microns, and more preferably in an uncured coating film of from about 3.0 to 4.8 mils/76.2 to 121.9 microns and most preferably from about 3.6 to 4.6 mils/91.4 to 116.8 microns. To provide cured liquid coating of at least 2.0 mils/50.8 microns, preferably from at least 2.5 mils/63.5 microns, and most preferably of at least 3.0 mils/76.2 microns, the liquid coating composition will have to be correspondingly applied in uncured film builds of from 2.5 mils/63.5 to 15 mils/381 microns. It will be appreciated that to provide cured powder coating films of at least 2.0 mils/50.8 microns, preferably from at least 4.0 mils/101.6 microns, and most preferably of at least 6.0 mils/152.4 microns, the uncured powder coating composition will be applied in the same corresponding film build.

The coating compositions described herein are preferably subjected to conditions so as to cure the applied coating layers. Although various methods of curing may be used, heat curing is preferred. Generally, heat curing is effected by exposing the coated article to elevated temperatures provided primarily by radiative heat sources. Curing temperatures will vary depending on the particular blocking groups used in the cross-linking agents, however they generally range between 90° C. and 180° C.

In a preferred embodiment, the cure temperature is preferably between 115° C. and 150° C., and more preferably at temperatures between 115° C. and 140° C. for a blocked acid catalyzed system. For an unblocked acid catalyzed system, the cure temperature is preferably between 80° C. and 100° C. The curing time will vary depending on the particular components used, and physical parameters such as the thickness of the layers, however, typical curing times range from 15 to 60 minutes, and preferably 15-25 minutes for blocked acid catalyzed systems and 10-20 minutes for unblocked acid catalyzed systems.

The invention is further described in the following example. The example is merely illustrative and does not in any way limit the scope of the invention as described and claimed. All parts are parts by weight unless otherwise noted.

### EXAMPLES

### Preparation 1. First, Hard Material

A mixture of 8.9 parts of methyl carbamate and 17.2 parts of Aromatic S-100 was heated under an inert atmosphere to 140° C. Then a mixture of 12.5 parts of hydroxyethyl methacrylate, 7.2 parts of hydroxypropyl methacrylate, 14.8 parts of cyclohexyl methacrylate, 1 part of ethylhexyl acrylate, 0.1 part of methacrylic acid and 5 parts of Perkadox AMBM-GR (obtained from Akzo Nobel) was added over four hours. Next, a mixture of 1.1 parts of toluene and 0.3 parts of Perkadox AMBM-GR is added over 15 minutes. Then 1.1 parts of toluene was added. The reaction mixture was then held at 140° C. for 2 hours and 15 minutes. The reaction mixture was then cooled, and 0.2 parts of dibutyl tin oxide, 0.36 parts of triisodecyl phosphate and 16.5 parts of toluene were added. The reaction mixture was then heated to reflux under an inert atmosphere. Once at reflux, the inert atmosphere was turned off and a methanol/toluene aztrotope was removed from the reaction mixture. After at least 95% of the hydroxy groups were converted to primary carbamate groups, the excess methyl carbamate and toluene were removed by vacuum distillation. The reaction product was then cooled and 13.8 parts of propanediol monomethyl ether were added.

### Preparation 2. First, Hard Material

A mixture of 19.5 parts of amyl acetate and 37 parts of Desmodur Z4470SN (obtained from Bayer) was heated to 60° C. under an inert atmosphere. Then 0.013 parts of dibutyl tin dilaurate and 1 part of amyl acetate were added. Next, 12.1 parts of hydroxypropyl carbamate were slowly added. During the addition, the reaction temperature was allowed to increase to 80° C. Then 1.7 parts of amyl acetate were added and the reaction mixture held at 80° C. until all of the hydroxypropyl carbamate was reacted. Then 0.5 parts of butanol, 19.1 parts of amyl acetate and 4.2 parts of isobutanol were added.

### Preparation 3. Second, Soft Material

A mixture of 59.6 parts of Pripol® 2030 (obtained from Uniqema), 17.6 parts of methyl carbamate, 0.11 parts of dibutyl tin oxide, 0.56 parts of triisodecyl phosphate, and 22.13 parts of toluene was heated under an inert atmosphere to reflux. Once at reflux, the inert atmosphere was turned off and a methanol/toluene aztrotope was removed from the reaction mixture. After at least 95% of the hydroxy groups were converted to primary carbamate groups, the excess methyl carbamate and toluene was removed by vacuum distillation.

### Preparation 4. Second, Soft Material

A mixture of 16.1 parts of dodecanediodic acid and 16.3 parts of xylene was heated under an inert atmosphere to 130° C. Then 34 parts of Cardura ELOP (obtained from Hexion) were slowly added. The reaction mixture was then heated to no more than 140° C. Once the reaction was complete, the reaction mixture was cooled to at least 100° C. and 13.6 parts of methyl carbamate, 0.28 parts of dibutyl tin oxide, 0.57 parts of triisodecyl phosphate and 9.5 parts of toluene were added. The reaction mixture was then heated to reflux. Once at reflux, the inert atmosphere was turned off and a methanol/toluene aztrotope was removed from the reaction mixture. After at least 95% of the hydroxy groups were converted to primary carbamate groups, the excess methyl carbamate and toluene was removed by vacuum distillation.

### Preparation 5. Second, Soft Material

Part One: A mixture of 30.9 parts of hydroxyethyl carbamate and 68.9 parts of epsilon-caprolactone was heated to 125° C. while bubbling nitrogen through the mixture. Once at 125° C., the nitrogen bubbler was removed and, while under an inert atmosphere, 0.18 parts of Fascat 2003 (obtained from King Industries) were added. The reaction mixture was then held at 130° C. until the reaction was complete.

Part Two: A mixture of 17.4 parts of Vestanat TMDI (obtained from CreaNova), 24.4 parts of anhydrous methyl amyl ketone and 0.06 parts of dibutyl tin dilaurate was heated under an inert atmosphere to 45° C. Then 57.0 parts of the reaction product from part one was slowly added. During the addition, the reaction mixture was not allowed to get above 81° C. The reaction mixture was then held at 80° C. until the reaction was done. Then 1.1 parts of i-butyl alcohol were added.

### Coating Composition Examples

Coating compositions were prepared using the materials of Preparations 1-5, and compared to a commercially available clearcoat coating composition, R10CG062, Batch #0101636094.

### Example 1

A coating composition was prepared by combining 491.7 parts by weight. of the resin of Preparation 3, 156.9 parts by weight of fully methylated melamine formaldehyde resin, 125.4 parts by weight of fumed silica dispersed in an acrylic resin having carbamate functionality, 6.1 parts by weight of hydroxyphenyl triazine ultraviolet light absorber, 13.0 parts by weight of an acrylated hindered amine light stabilizer, 1.5 parts by weight of a polyacrylate anti-pop polymer, 72.9 parts by weight of a blocked acid catalyst solution, 1.2 parts by weight of a polysiloxane solution, 44.6 parts by weight hydroxyphenyl benzotriazole solution, and 86.7 parts by weight n-butanol.

### Example 2

A coating composition was prepared by combining 309.3 parts by weight. of the resin of Preparation 4, 203.4 parts by weight of the resin of Preparation 2, 184.7 parts by weight of RESIMENE 747 (available from Solutia Inc.), 136.5 parts by weight of fumed silica dispersed in an acrylic resin having carbamate functionality, 6.6 parts by weight of hydroxyphenyl triazine ultraviolet light absorber, 14.2 parts by weight of an acrylated hindered amine light stabilizer, 1.7 parts by weight of a polyacrylate anti-pop polymer, 79.4 parts by weight of a blocked acid catalyst solution, 1.3 parts by weight of a polysiloxane solution, 48.5 parts by weight hydroxyphenyl benzotriazole solution, and 14.5 parts by weight n-butanol.

### Example 3

A coating composition was prepared by combining 223.3 parts by weight. of the resin of Preparation 1, 200.9 parts by weight of the resin of Preparation 4, 227.4 parts by weight of fully methylated melamine formaldehyde resin, 141.6 parts by weight of fumed silica dispersed in an acrylic resin having carbamate functionality, 6.9 parts by weight of hydroxyphenyl triazine ultraviolet light absorber, 14.7 parts by weight of an acrylated hindered amine light stabilizer, 1.7 parts by weight of a polyacrylate anti-pop polymer, 82.4 parts by weight of a blocked acid catalyst solution, 1.3 parts by weight of a polysiloxane solution, 50.3 parts by weight hydroxyphenyl benzotriazole solution, and 39.3 parts by weight n-butanol.

### Example 4

A coating composition was prepared by combining 243.5 parts by weight. of the resin of Preparation 2, 210.7 parts by weight of the resin of Preparation 4, 207.7 parts by weight of fully methylated melamine formaldehyde resin, 141.6 parts by weight of fumed silica dispersed in an acrylic resin having carbamate functionality, 6.9 parts by weight of hydroxyphenyl triazine ultraviolet light absorber, 14.7 parts by weight of an acrylated hindered amine light stabilizer, 1.7 parts by weight of a polyacrylate anti-pop polymer, 82.4 parts by weight of a blocked acid catalyst solution, 1.3 parts by weight of a polysiloxane solution, 50.3 parts by weight hydroxyphenyl benzotriazole solution, and 49.5 parts by weight n-butanol.

### Example 5

A coating composition was prepared by combining 575.0 parts by weight of a polyurethane resin having carbamate functionality, 138.5 parts by weight of fully methylated melamine formaldehyde resin, 129.8 parts by weight of fumed silica dispersed in an acrylic resin having carbamate functionality, 6.3 parts by weight of hydroxyphenyl triazine ultraviolet light absorber, 13.5 parts by weight of an acrylated hindered amine light stabilizer, 1.6 parts by weight of a polyacrylate anti-pop polymer, 75.5 parts by weight of a blocked acid catalyst solution, 1.2 parts by weight of a polysioloxane solution, 46.2 parts by weight hydroxyphenyl benzotriazole solution, and 12.4 parts by weight n-butanol.

The physical properties of the example coating compositions of Examples 1-5 were compared to the control. The measurements are shown in the following table.

| | Wt. % | | | |
|---|---|---|---|---|
| Composition | Nonvolatiles | Wt./Gal. | Viscosity (cp) | VOC |
| Example 1 | 59.5 | 8.46 | 106 | 3.43 |
| Example 2 | 63.7 | 8.55 | 121 | 3.10 |
| Example 3 | 63.0 | 8.38 | 120 | 3.10 |
| Example 4 | 62.1 | 8.55 | 122 | 3.24 |
| Example 5 | 55.0 | 8.31 | 123 | 3.74 |
| R10CG062 | 52.1 | 8.26 | 110 | 3.96 |

### Testing of Coating Compositions

The clearcoat coating compositions of Examples 1-5 and control example R10CG062 were applied by air atomization wet-on-wet over a commercial waterborne basecoat composition (E54KW401, obtained from BASF Corp., applied for a cured film thickness of 0.6 to 0.8 mil) to a clearcoat film thickness of about 1.6 to 1.9 mils. The applied coating layers were cured at about 280° F. (137° C.) for about 20 minutes.

STM Test Methods used to obtain the data shown are: Q-Sun Test—D7356, 20°Gloss—D523, Tukon Hardness—D1474, Weight per Gallon—D3363-74, and Weight Non-Volatile—D1475, QCT—D4585. SAE Test Methods used to obtain data shown are: QUV—J2020 with 8 hours UV, 4 hours humidity, and WOM—J1960. Other tests procedures are: CROCKMETER—An Atlas A.A.T.C.C. Crockmeter mounted with a ⅝″ dowel covered with felt and 9 μm 3M 281Q WETODRY polishing paper, was used to abrade the coating surface with ten (10) double strokes. The % Gloss Retention after testing was then calculated for the tested surface area. XYLENE DOUBLE RUB TEST—A 32 oz. Ball Peen Hammer head was covered with a 4 layer thick 4″×4″ cheesecloth, soaked in xylenes, and drawn across and back over the same area for each double rub.

The results of testing the example coating compositions of Examples 1-5 and the control are shown in following tables.

| | | 9 Mic | | | |
|---|---|---|---|---|---|
| | | Crockmeter | 50 xylene | 3000 hr | 3500 hr |
| | | % | doublerubs | QUV % | WOM % |
| | 20° | Gloss | (5-best, | Gloss | Gloss |
| Composition | Gloss | retention | 4 = pass) | retention | retention |
| Example 1 | 89 | 95 | 5 | 77 | 96 |
| Example 2 | 88 | 88 | 5 | 78 | 99 |
| Example 3 | 90 | 91 | 5 | 10 | 89 |
| Example 4 | 87 | 83 | 5 | 62 | 100 |
| Example 5 | 89 | 76 | 4.5 | 69 | 97 |
| R10CG062 | 88 | 81 | 5 | 65 | 98 |

| | 2 day 140° F. QCT | | |
|---|---|---|---|
| | Pre-test | | Q-Sun |
| | adhesion loss/ | | 400 hr. |
| | post-test | | rating |
| Composition | adhesion loss | Comments | (lower is better) |
| Example 1 | 0/0 | slight whitening, | 8 |
| | | recovered in two hours | |
| Example 2 | 0/0 | OK | 6 |
| Example 3 | 0/0 | OK | 6 |
| Example 4 | 0/0 | OK | 8 |
| Example 5 | 0/0 | whitening, | 5 |
| | | recovered in two hours | |
| R10CG062 | 0/0 | OK | 5 |

The testing results in the tables above demonstrate that these low VOC coatings are as durable, and perform as well or better than the conventional clear coat, R10CG062. These low VOC coatings have good properties with the benefit of lower environmental impact.

The prepared panels were tested and the results recorded.

The invention has been described in detail with reference to preferred embodiments thereof. It should be understood, however, that variations and modifications can be made within the spirit and scope of the invention and of the following claims.

What is claimed is:

1. A coating composition comprising a thermosetting binder, said binder comprising:
a crosslinker or a plurality of crosslinkers,
a first, hard material having a glass transition temperature of at least about 40° C., a number average molecular weight of 2000 or less, and functionality reactive with the crosslinker or with at least one of the plurality of crosslinkers under cure conditions; and wherein
a second, soft material that is an amorphous mixture of four or more compounds, each of the compounds related to at least one other of the compounds as an isomer, near isomer, or homologous structure, and each of the compounds having from two to four functional groups that form thermally irreversible linkages with the crosslinker or with at least one of the plurality of crosslinkers under cure conditions, wherein each functional group is separated from each other functional group by at least four carbon atoms.

2. A coating composition according to claim 1, wherein the coating composition is nonaqueous.

3. A coating composition according to claim 1, wherein the compounds of the second, soft material are asymmetric.

4. A coating composition according to claim 1, wherein the compounds of the second, soft material include compounds that are isomers or near isomers.

5. A coating composition according to claim 1, wherein at least two functional groups of one compound of the second, soft material are separated from each other by atoms other than carbon atoms.

6. A coating composition according to claim 1, wherein the amorphous mixture has a polydispersity of about 1.5 or less.

7. A coating composition according to claim 1, further comprising a material having only one group on average per molecule that is reactive with the crosslinker or at least one of the plurality of crosslinkers.

8. A coating composition according to claim 1, wherein the first, hard material is an oligomer or polymer.

9. A coating composition according to claim 1, wherein the first, hard material has a glass transition temperature of at least about 60° C.

10. A coating composition according to claim 1, wherein the first, hard material has an equivalent weight of about 150 to about 600 grams per equivalent of functionality reactive with the crosslinker or with the at least one of the plurality of crosslinkers.

11. A coating composition according to claim 1, wherein the functionality of the first, hard material reactive with the crosslinker or with the at least one of the plurality of crosslinkers comprises carbamate functionality.

12. A coating composition according to claim 1, wherein the functionality of the first, hard material is reactive with the crosslinker or with the at least one of the plurality of crosslinkers to produce thermally irreversible chemical linkages.

13. A coating composition according to claim 1, wherein the first, hard material is an acrylic polymer having a number average molecular weight of about 1500 or less.

14. A coating composition according to claim 1, wherein the first, hard material is a β-hydroxy carbamate or γ-hydroxy carbamate compound having a structure 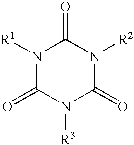
wherein each of R¹, R², and R³ independently comprises a carbamate group and a hydroxyl group on a carbon beta or gamma to the carbamate group.

15. A coating composition according to claim 14, wherein each of R¹, R², and R³ independently is

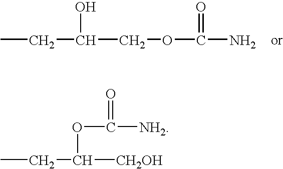

16. A coating composition according to claim 14, wherein each of R¹, R², and R³ independently is 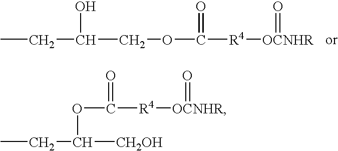
wherein R⁴ is alkylene, alkylarylene, or arylene, and R is H or alkyl.

17. A coating composition according to claim 16, wherein R⁴ is alkylene and R is H.

18. A coating composition according to claim 14, wherein each of R¹, R², and R³ independently is 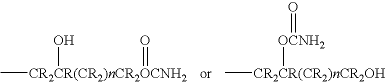
wherein each R is independently H or an alkyl group containing one to six carbon atoms and which may additionally have hetero atom linking groups of oxygen, nitrogen, silane, boron, phosphorous and combinations thereof, and n is an integer from 1 to 4.

19. A coating composition according to claim 1, wherein the first, hard material has at least two urethane or urea groups.

20. A coating composition according to claim 19, wherein the first, hard material comprises a structure selected from the group consisting of 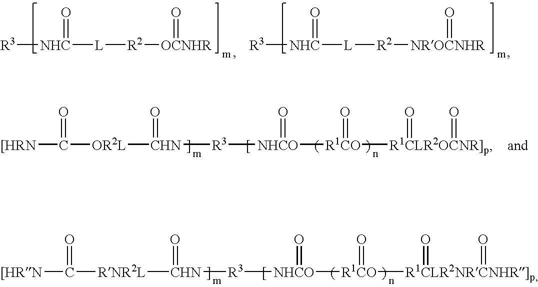
wherein R is H or alkyl, R′ and R″ are each independently H or alkyl or R′ and R″ together form a heterocyclic ring structure, R¹ is alkylene or arylalkylene, R² is alkylene or substituted alkylene, R³ is alkylene, alkylarylene, arylene, or a structure that includes a cyanuric ring, a urethane group, a urea group, a carbodiimide group, a biuret structure, or an allophonate group, n is an integer from 0 to about 10, m is an integer from 2 to about 6, L is O, NH, or NR⁴, where R⁴ is an alkyl, p is an integer from 1 to 5, and m+p is an integer from 2 to 6.

21. A coating composition according to claim 20, wherein R is H, R′ and R″ are each H or R′ and R″ together form an ethylene bridge, R¹ is alkylene of 5 to 10 carbon atoms, R² is alkylene or substituted alkylene of about 2 to about 4 carbon atoms, R³ is alkylene or a structure that includes a cyanuric ring, n is an integer from 0 to about 5, m is 2 or 3, p is 1 or 2, and m+p is 3.

22. A coating composition according to claim 20, wherein R³ is a member selected from the group of hexamethylene with m+p being 2, 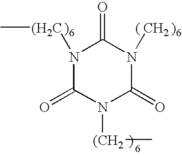
with m+p being 3, 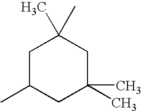
with m+p being 2, 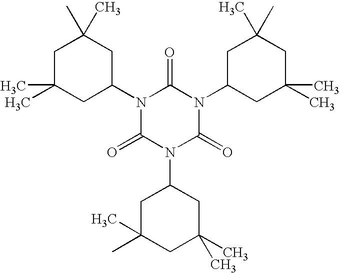
with m+p being 3, and mixtures of these and L is an oxygen atom.

23. A coating composition according to claim 1, wherein the first, hard material comprises a compound having a structure 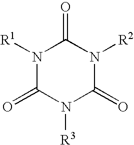
wherein each of R¹, R², and R³ is independently
CH₂CH₂LR⁴F,
wherein L is a urethane or ester group, R⁴ is alkylene, alkylarylene, or arylene, and F is an alkyl group comprising a functionality reactive with the crosslinker or at least one of the plurality of crosslinkers.

24. A coating composition according to claim 1, wherein all of the functional groups of the second, soft material form irreversible linkages under curing conditions with the crosslinker or one of the plurality of crosslinkers.

25. A coating composition according to claim 1, wherein each of the functional groups of the second, soft material is separated from each other functional group by at least six carbon atoms.

26. A coating composition according to claim 1, wherein each of the functional groups of the second, soft material is separated from each other functional group by at least ten carbon atoms.

27. A coating composition according to claim 1, wherein atoms other than carbon atoms separate at least two of the functional groups of the second, soft material.

28. A coating composition according to claim 1, wherein the mixture of the second, soft material has a polydispersity of about 1.2 or less.

29. A coating composition according to claim 1, wherein at least one compound of the second, soft material is asymmetric.

30. A coating composition according to claim 1, wherein the second, soft material comprises at least one non-cyclic aliphatic compound and at least one cycloaliphatic compound.

31. A coating composition according to claim 1, wherein the second, soft material comprises a reaction product of a polyfunctional reactant with a mixture of fatty acid isomers, fatty acid homologs, or both fatty acid isomers and fatty acid homologs.

32. A coating composition according to claim 1, wherein the second, soft material comprises a reaction product of a polyfunctional reactant with a mixture of epoxide esters of fatty acid isomers, homologs, or both isomers and homologs.

33. A coating composition according to claim 32, wherein the epoxide esters of fatty acid isomers, homologs, or both are glycidyl ester of neoalkanoic acid isomers, homologs, or both.

34. A coating composition according to claim 33, wherein the polyfunctional reactant is selected from the group consisting of polycarboxylic acids and anhydrides thereof.

35. A coating composition according to claim 33, wherein the second, soft material has carbamate functionality.

36. A coating composition according to claim 34, wherein the polycarboxylic acid has two internal ester groups.

37. A coating composition according to claim 1, wherein the second, soft material comprises a mixture of hyperbranched compounds.

38. A coating composition according to claim 37, wherein the hyperbranched compounds have a core that is a residue of a polyol.

39. A coating composition according to claim 1, wherein the second, soft material comprises at least carbamate functionality and hydroxyl functionality.

40. A coating composition according to claim 1, wherein the second, soft material comprises a reaction product of a lactone or a hydroxy carboxylic acid and a compound comprising a carbamate or urea group or a group that is converted to a carbamate or urea group after the reaction and a group that is reactive with the lactone or hydroxy carboxylic acid.

41. A coating composition according to claim 1, wherein the second, soft material comprises a mixture of diethyloctanediol dicarbamates.

42. A coating composition according to claim 1, wherein the second, soft material comprises a mixture of diethyloctanediol diallophanates.

43. A coated substrate prepared by a method comprising applying the coating composition of claim 1 as a clearcoat layer, and curing the applied coating composition.

44. A coating composition comprising a thermosetting binder, said binder comprising:
a crosslinker or a plurality of crosslinkers,
a first, hard material having an equivalent weight of about 220 to about 850 grams per equivalent of functionality reactive with the crosslinker or with at least one of the plurality of crosslinkers under cure conditions, which, if reacted alone with the crosslinker or with the at least one of the plurality of crosslinkers, would form a film having a Tukon hardness of 16 or more; and
a second, soft material having an equivalent weight of 200 to 2000 grams per equivalent of functionality reactive with the crosslinker or with at least one of the plurality of crosslinkers under cure conditions, which, if reacted alone with the crosslinker or with the at least one of the plurality of crosslinkers, would form a film having a Tukon hardness of less than 4;
wherein the coating composition forms a cured film having a Tukon hardness of from about 7 to about 12.

45. A coating composition according to claim 44, wherein the second, soft material that is an amorphous mixture of four or more compounds, each of the compounds related to at least one other of the compounds as an isomer, near isomer, or homologous structure, and each of the compounds having from two to four functional groups that form thermally irreversible linkages with the crosslinker or with at least one of the plurality of crosslinkers under cure conditions, wherein each functional group is separated from each other functional group by at least four carbon atoms.

46. A coated substrate prepared by a method comprising applying the coating composition of claim 44 as a clearcoat layer, and curing the applied coating composition.
